(19) United States
(12) Patent Application Publication
(10) Pub. No.: US 2023/0109645 A1
(43) Pub. Date: Apr. 6, 2023

(54) CLEAN FUEL CELL ECOSYSTEM FOR FUEL CELL ELECTRIC VEHICLES

(71) Applicant: Lyten, Inc., San Josw, CA (US)

(72) Inventors: Michael Stowell, Sunnyvale, CA (US); Jacques F. Nicole, Palo Alto, CA (US)

(21) Appl. No.: 18/077,980

(22) Filed: Dec. 8, 2022

Related U.S. Application Data
(63) Continuation-in-part of application No. 17/960,293, filed on Oct. 5, 2022.
Application No. 17/960,293 is a continuation-in-part of application No. 17/699,027, filed on Mar. 18, 2022.
Application No. 17/699,027 is a continuation of application No. 16/997,417, filed on Aug. 19, 2020, now Pat. No. 11,462,728.
Application No. 16/997,417 is a continuation of application No. 16/223,785, filed on Dec. 18, 2018, now Pat. No. 10,756,334.
(60) Provisional application No. 63/252,781, filed on Oct. 6, 2021.
(60) Provisional application No. 62/610,018, filed on Dec. 22, 2017.

(51) Int. Cl. H01M 4/1393; H01M 4/04; H01M 4/36; H01M 4/38; H01M 4/62; C01B 32/182

(52) U.S. Cl. CPC H01M 4/1393; H01M 4/0404; H01M 4/0421; H01M 4/366; H01M 4/38; H01M 4/625; C01B 32/182; H01M 2004/021

(57) ABSTRACT

A greenhouse gas negative emissions system. Embodiments use a dissociating reactor to produce fuel as well as carbonaceous materials, both of which are used in environmentally-clean fuel cells. A high-power reactor harmlessly dissociates methane into solid carbon and hydrogen. The methane is dissociated rather than being burned, thus permanently abating greenhouse gas emissions that would result from combustion of methane thus, the reactor operates as a negative emissions system. The dissociated hydrogen is distributed as hydrogen gas (H₂). The hydrogen gas is stored for use in a clean fuel consuming apparatus that converts H₂ to water (H₂O) and electric energy. A first portion of the dissociated carbon is used to produce a fuel cell array that is used in environmentally-clean vehicles. A second portion of the dissociated carbon is used in other carbon-containing applications, such as lightweight carbon fiber components, carbon fiber reinforced plastics, carbon-containing building materials, and so on.

### CROSS-REFERENCE TO RELATED APPLICATIONS

This application is a Continuation in Part application of U.S. patent application Ser. No. 17/960,293 filed on Oct. 5, 2022 and entitled “Carbon-Enhanced Fuel Cells,” which claims the benefit of U.S. Provisional Patent Application No. 63/252,781, “Carbon-Enhanced Fuel Cells” filed on Oct. 6, 2021. This application is a continuation in part (CIP) of U.S. patent application Ser. No. 17/699,027 “Carbon Structured Including An Electrically Conductive Material” filed on Mar. 18, 2022, which is a continuation of U.S. patent application Ser. No. 16/997,417, “Structured Composite Materials” filed on Aug. 19, 2020 now U.S. Pat. No. 11,462,728, which is a continuation of U.S. patent application Ser. No. 16/223,785, “Structured Composite Materials” filed on Dec. 18, 2018 now U.S. Pat. No. 10,756,334, which claims the benefit of U.S. Provisional Patent Application No. 62/610,018, “Structured Composite Materials” filed on Dec. 22, 2017. U.S. patent application Ser. Nos. 17/699,027, 16/997,417, 16/223,785, 62/610,018, and 63/252,781 are hereby incorporated by reference in their entirety.

### BACKGROUND

Global climate change has become one of the most profound issues facing our society. Climate change generally refers to long-term shifts in temperatures and weather patterns. The significant rate of increase in temperature change since the modern industrial era, however, has led to the acknowledgment that anthropogenic activities have contributed to global climate change in the last century. This is primarily due to the burning of fossil fuels like coal, oil, and natural gas. Combustion of these fossil fuels produces heat-trapping gases, referred to as greenhouse gases. Greenhouse gases that are trapped in the atmosphere act like a heat insulator, trapping the sun's heat and raising Earth's surface temperatures. Although heat insulating gases can be found naturally in low proportions in Earth's atmosphere, the proportions have increased significantly since the beginning of the last century.

Studies conducted by the United Nations have shown that greenhouse gas proportions in our atmosphere are at their highest levels in 2 million years, and emissions of more and more greenhouse gasses continue to increase, which leads to global warming, which has in turn lead to the situation that the Earth is now about 1.1° C. warmer than it was 150 years ago. While scientists and government reviewers generally agree that limiting this temperature rise to no more than 1.5° C. will help avoid disastrous climate impacts and maintain a livable climate, the science suggests that at current rates, the Earth's temperature is projected to increase by a further 2.1° C. by the end of this century. The opportunity for mankind to stem further increases in global temperatures is thus slipping away quickly unless deliberate action is taken now to reduce emissions of greenhouse gases into the atmosphere.

Activities chiefly associated with emissions of greenhouse gases are the burning of fossil fuels for electric power generation, and combustion of fossil fuels (e.g., gasoline) for transportation. Virtually all sectors of heavy industry, from energy production, manufacturing, mining, transport, construction, agriculture and land use, etc. are major emitters of greenhouse gases.

As mentioned above, the two industries that are chiefly associated with the emission of greenhouse gases are (1) electric power generation and (2) transportation. Both industries have traditionally relied on combustion of fossil fuels to generate electrical power, and provide motive power for cars, trucks, busses, heavy equipment, and so on. The combustion of fossil fuels (i.e., coal, oil, and natural gas), is deemed to be the largest single contributor to global climate change, accounting for over 75% of greenhouse gas emissions and accounting for nearly 90% of all carbon dioxide emissions.

Traditional fossil fuel burning plants are highly inefficient, wastefully burning fossil fuel to generate steam, which is then wastefully used to generate electricity. Internal combustion engines (ICE) are also inefficient in that they convert the chemical energy stored in the fuel into thermal energy via combustion, which is then converted into mechanical energy that is then used for motive power.

As a viable alternative to combustion systems, fuel cells generate power through electrochemical reactions, rather than through combustion. A typical proton exchange fuel cell combines hydrogen and oxygen to generate electricity, heat, and water. Various other fuel cells that can use fuels other than hydrogen gas have emerged as a clean energy source that are capable of highly efficient energy conversion.

Significantly, fuel cells differ from batteries in that they require a continuous source of fuel and oxygen to sustain the electrochemical reaction, Fuel cells can produce electricity continuously for as long as fuel and oxygen are supplied. Fuel cells come in various different types, such as phosphoric acid fuel cells, solid acid fuel cells, alkaline fuel cells, and solid oxide fuel cells.

Of the various types of fuel cells, solid oxide fuel cells (SOFCs) have shown great potential for providing efficient power generation for industrial, residential, transportation, and military applications. Unlike combustion-based power generators, SOFCs convert the chemical energy of fuel directly into electrical energy, without incurring the inefficiencies associated with steam generation and the inefficiencies associated with conversion of mechanical energy to electrical energy. The simplicity of fuel cell systems yield the potential for high efficiency power generation.

One barrier to the widespread use and commercialization of SOFCs, however, has been the expensive manufacturing process, which increases the overall price of SOFC systems, sometimes leading to impracticalities. More specifically, existing fuel cell fabrication processing is time consuming and requires large amounts of energy. Unfortunately, such large amounts of energy use contributes to the creation of harmful gases that exacerbate present climate change issues, and prevent SOHCs and similar fuel cells from being a truly green energy source needed to combat global warming trends.

What is needed, therefore, are more efficient fuel cell fabrication processes that produce efficient fuel cells while preventing or minimizing greenhouse gas emissions.

### BRIEF SUMMARY OF EMBODIMENTS

Embodiments are directed to production of a multi-cell fuel cell that is an innovative combination of fuel cell design and production techniques. The present embodiments provide significant energy savings and lower carbon footprint during production. In addition to speeding up manufacturing, increasing cell efficiency and robustness while lowering overall fuel cell cost, realization of this concept finally overcomes the issues that have prevented fuel cells from achieving broad adoption as mainstream motive energy production devices.

Embodiments include systems and methods for producing clean energy from methane drawn from methane deposits. Such embodiments comprise a high-power reactor that harmlessly dissociates methane (CH₄) into solid carbon (i.e., not gaseous forms of carbon) and hydrogen (H) for distribution as hydrogen gas (H₂). The dissociating reactor dissociates the methane rather than burning the methane, thus permanently abating the dissociated methane without the unwanted emissions (e.g., CO₂ emissions) that arise from burning the methane.

Embodiments further include a storage facility for storing the hydrogen gas for subsequent supply to an apparatus (e.g., a fuel cell) that converts the H₂ and oxygen to water (H₂O). A portion of the dissociated carbon is used to produce a fuel cell array that is in turn used in a vehicle. Such vehicles can include a fuel cell electric vehicle (FCEV), a battery electric vehicle (BEV), a hybrid electric vehicle (HEV), or a plug-in hybrid electric vehicle (PHEV). The methane can be sourced from any one of: a natural gas deposit, a landfill site, and a livestock facility, or any other facility or site where methane can be collected for distribution to the high-power reactor, such as through a methane capture and delivery system.

Embodiments yet further include a system for preventing emissions of greenhouse gases during the manufacture of fuel cells A first stage sources and distributes methane gathered from natural terrestrial sources. In a second stage, a negative emissions reactor dissociates the sourced methane into separate elemental components. A further stage isolates a portion of the dissociated carbon for use in the production of fuel cells, which are in turn used in vehicles or power generating devices. A remainder of the carbon is used in one or more carbon-containing applications such as in carbon-containing reinforced plastics, carbon-containing building materials, carbon-containing methane sorbents disposed into landfills, etc. For this embodiment, the terrestrial sources may be a natural gas deposit, a landfill site, and a livestock facility, and the methane is collected for distribution to the reactor through a methane capture and delivery system. The reactor may produce graphene that as a component of the fuel cells, and wherein the fuel cells comprise multi-cell solid oxide fuel cell (SOFC) arrays, and the carbon for the fuel cells may be formed into an integral structure with porous media and a plurality of conductive particles, and in turn further comprising one of: a metal-decorated porous 3D carbonaceous material, or a 3-phase boundary surface area; or further comprising a plurality of graphene-containing conjoined allotropes.

Some deployments include a storage facility for storing the hydrogen as hydrogen gas, which is in turn used as a fuel supply for use in various FCEVs. In some embodiments, the reactor produces materials that are used to produce proton exchange membrane (PEM) fuel cells, whereas in other embodiments, the reactor produces materials that are used in fuel cells that comprise multi-cell solid oxide fuel cell (SOFC) arrays. The fuel cells may include an integral structure with porous media and a plurality of conductive particles, and in turn further comprising one of: a metal-decorated porous 3D carbonaceous material, or a 3-phase boundary surface area; or further comprising a plurality of graphene-containing conjoined allotropes.

Embodiments are yet further directed to methods of making and using or deploying the systems and elements for preventing emissions of methane or permanently dissociating the methane.

### INCORPORATION BY REFERENCE

Each publication, patent, and/or patent application mentioned in this specification is herein incorporated by reference in its entirety to the same extent as if each individual publication and/or patent application was specifically and individually indicated to be incorporated by reference.

### BRIEF DESCRIPTIONS OF THE DRAWINGS

FIG. 1A illustrates an overall fuel cell production cycle for producing efficient fuel cells with zero or negative emission impacts, and with hydrogen as a possible fuel source, under some embodiments.

FIG. 1B illustrates an alternate fuel cell production cycle for producing efficient fuel cells with zero or negative emission impacts, and with methane as a possible fuel source, under some embodiments.

FIG. 2 illustrates a dissociating reactor for use in the system of FIG. 1A, under some embodiments.

FIG. 3 illustrates a side view of a fuel cell.

FIG. 4 illustrates a side view of a multiple fuel cell assembly, according to some embodiments.

FIG. 5 illustrates a side view of a multiple fuel cell assembly, according to some embodiments.

FIG. 6 illustrates a side view of a fuel cell having a 3-phase reaction area that has a pattern of grooves, according to some embodiments.

FIG. 7 illustrates a side view of a fuel cell having a planar 3-phase reaction area, according to some embodiments.

FIG. 8 illustrates a side view of a fuel cell having an anode, electrolyte, and cathode formed from sintered carbon particles, according to some embodiments.

FIG. 9 illustrates a side view of a fuel cell, according to some embodiments.

FIG. 10A illustrates a perspective view of a tubular fuel cell assembly, according to some embodiments.

FIG. 10B illustrates a cross section of a tubular fuel cell assembly, according to some embodiments.

FIG. 10C illustrates a front view of a multiple parallel tubular fuel cell assembly, according to some embodiments.

FIG. 11 illustrates an enlarged view of decorated carbon particles, according to some embodiments.

FIG. 12 illustrates a process for sintering decorated carbon particles, according to some embodiments.

FIG. 13 illustrates a flow chart for fabricating a fuel cell, according to some embodiments.

FIG. 14 illustrates a photograph of a cross section of a fuel cell, according to some embodiments.

### DETAILED DESCRIPTION

As stated above, fuel cells including solid oxide fuel cells (SOFCs) have great potential for providing efficient power generation many common applications by converting a fuel's chemical energy directly into electrical energy. The simplicity of SOFC systems thus provides the potential for high efficiency power generation. Present production methods, however, can be very time consuming and expensive in terms of requiring large amounts of energy. Embodiments are directed to a fuel cell production process that provides zero emissions and even offsets greenhouse gas emissions through the complete and permanent dissociation of methane that would otherwise be either burned or released.

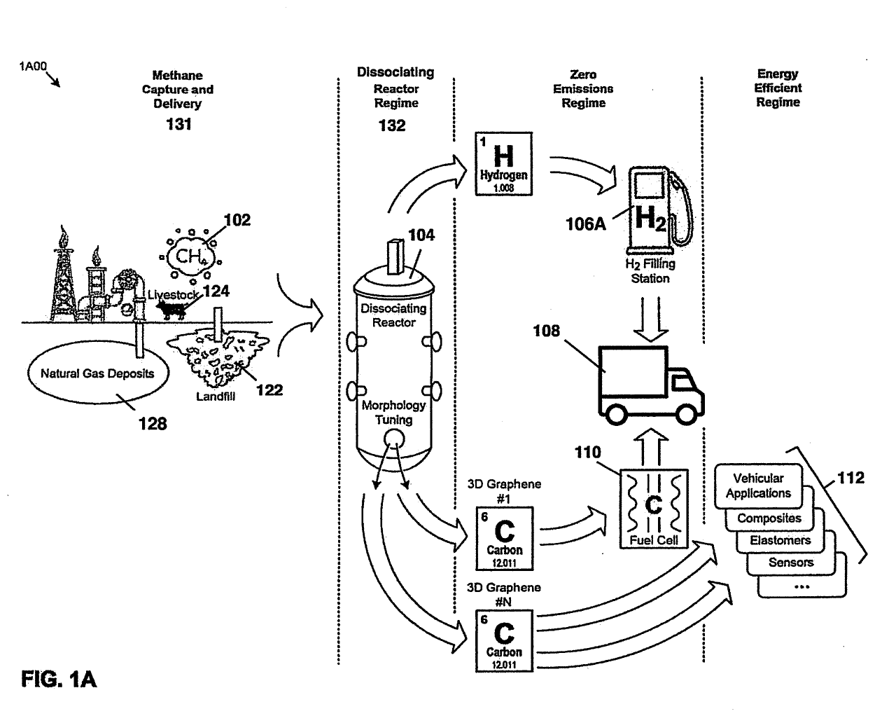

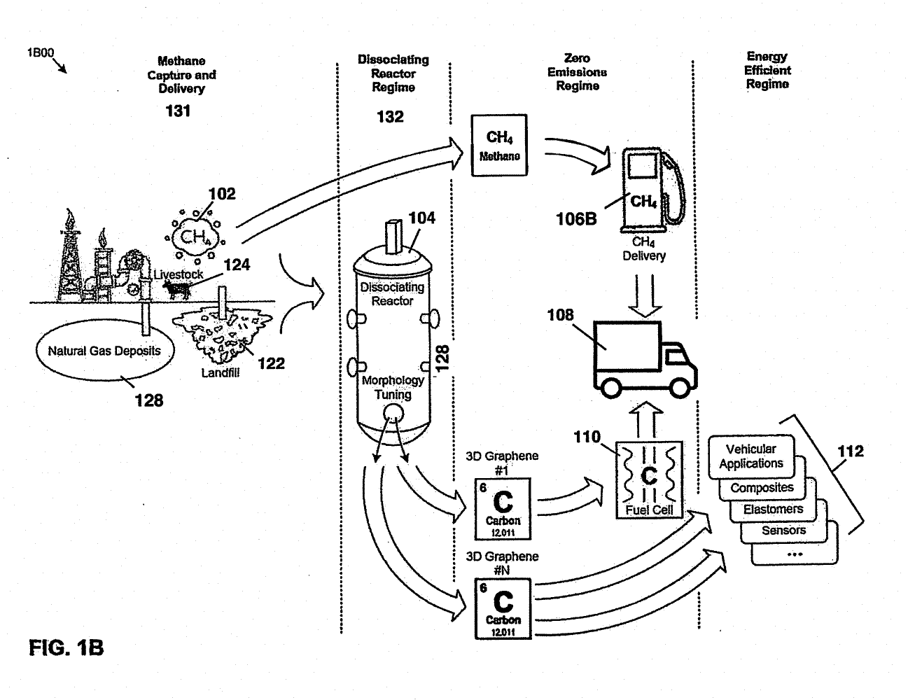

FIG. 1A illustrates an overall fuel cell production cycle for producing efficient fuel cells with zero or negative emission impacts, under some embodiments. As shown in FIG. 1A, system 1A00 includes a source of methane (CH₄) for processing in a dissociating reactor 104 to produce hydrogen (H) and carbon (C). The hydrogen can be used in a hydrogen filling station 106A to provide hydrogen as a fuel to power to vehicles, such as the shown fuel cell electric vehicle 108. The carbon produced in dissociating reactor 104 can be used to produce fuel cell 110, and dissociating reactor 104 can also produce carbons for other carbon-containing applications 112 that are in turn used in the production of vehicles of any varieties (e.g., carbon fiber parts, panels, and so on). As can be seen in FIG. 1A, the original methane is processed and utilized in a manner that provides hydrogen as a direct fuel for electrical power in practical uses, as well as useful carbons for use in myriad downstream applications.

As shown in system 1A00, the methane 102 is provided by any one or more natural sources, such as natural gas deposits 128, landfill 122, and livestock 124. Natural gas is generally a mixture of light hydrocarbons including methane, ethane, propane, butanes, and pentanes, along with some other compounds (e.g., helium, nitrogen, CO₂, etc.). Although the composition of natural gas varies in accordance with many factors, the primary component of natural gas is methane (typically at least 90%). Relatively significant amounts of methane can also be generated from decomposing material such as found in landfills and garbage collection sites, as well as livestock 124, such as cattle. Methane is lighter than air so it is possible to capture methane from such sources using gas recovery systems enclosing these sources. The methane capture and recovery stage 131 captures the methane from the source or sources and delivers it to a dissociating reactor 104 for further processing.

In an embodiment, certain procedures and systems are used to capture, abate, and/or repurpose the compounds produced as by-products of the fuel cell production process of FIG. 1A. For example, carbon monoxide (CO) may be converted to carbon and oxygen through the use of a catalytic converter. Similarly, carbon dioxide may be similarly processed and treated to produce harmless gaseous components. For example, a 2-way catalytic converter may be used to oxidize carbon monoxide to carbon dioxide, or a 2-way catalytic converter may be used to oxidize hydrocarbons to carbon dioxide and water. A 3-way catalytic converter may be used to treat nitric oxide and nitrogen dioxide, and/or similar by-products, and so on.

For the embodiment of FIG. 1A, the hydrogen produced by the dissociating reactor can be used to directly power a fuel cell electric vehicle 108 through supply by a hydrogen filling station 106A. Alternatively, other compounds may also be used to directly power the vehicle. FIG. 1B illustrates an embodiment of the fuel cell production cycle for producing efficient fuel cells in which methane instead of hydrogen is used as a fuel in the fuel cell for fuel cell electric vehicle 108. For this embodiment, the methane 102 produced in capture stage 131 is captured and stored in an appropriate methane capture and storage facility. The methane is then provided to a methane delivery system such as methane filling station 106B for use by the fuel cell electric vehicle 108.

It should be noted that for purposes of description, embodiments may be described with respect to either the system of FIG. 1A or FIG. 1B with respect to the common components although only one figure or embodiment may be cited.

### Dissociating Reactor

In an embodiment, the methane 102 is processed in a dissociating reactor regime (or stage) 132 comprising dissociating reactor 104. The dissociating reactor 104 comprises a microwave energy source that provides microwave energy, and a field-enhancing waveguide coupled to the microwave energy source. The field-enhancing waveguide has a first cross-sectional area and a second cross-sectional area. The field-enhancing waveguide includes a field-enhancing zone between the first cross-sectional area and the second cross-sectional area. The field-enhancing waveguide also includes a plasma zone and a reaction zone. In some embodiments, the second cross-sectional area is smaller than the first cross-sectional area, is farther away from the microwave energy source than the first cross-sectional area, and extends along a reaction length that forms the reaction zone of the field-enhancing waveguide. The microwave energy propagates in a direction along the reaction length. The processing reactor also includes a supply gas inlet into which a supply gas is flowed, and a process inlet into which a process input material is flowed into the reaction zone. The supply gas inlet is upstream of the reaction zone. In the reaction zone, a majority of the supply gas flow is parallel to the direction of the microwave energy propagation. The supply gas is used to generate a plasma in the plasma zone to convert the process input material into separated components in the reaction zone, where the converting of the process input material occurs at a pressure of at least 0.1 atmosphere.

An example reactor is described in U.S. Pat. No. 9,767,992, assigned to the assignee of the present application, and which is incorporated by reference in its entirety.

In an embodiment, the processed material input to dissociating reactor 104 is methane 102, which is dissociated into separate components comprising hydrogen and nanoparticulate carbon, as shown in FIG. 1A. In some embodiments, the process material is carbon dioxide with water, and the separated components are oxygen, carbon and water. Other processed materials may be dissociated into other separate components, in certain alternative embodiments.

As used herein, the term “field-enhancing waveguide” (FEWG) refers to a waveguide with a first cross-sectional area and a second cross-sectional area, where the second cross-sectional area is smaller than the first cross-sectional area and is farther away from the microwave energy source than the first cross-sectional area. The decrease in cross-sectional area enhances the field by concentrating the micro-wave energy, with the dimensions of the waveguide being set to maintain propagation of the specific microwave frequency being used. The second cross-sectional area of the FEWG extends along a reaction length that forms the reaction zone of the FEWG. There is a field-enhancing zone between the first cross-sectional area and the second cross-sectional area of a FEWG. In some embodiments, the field-enhancing zone can change cross-sectional area in a continuous manner (e.g., linearly or non-linearly) or an abrupt manner (e.g., through one or more discrete steps).

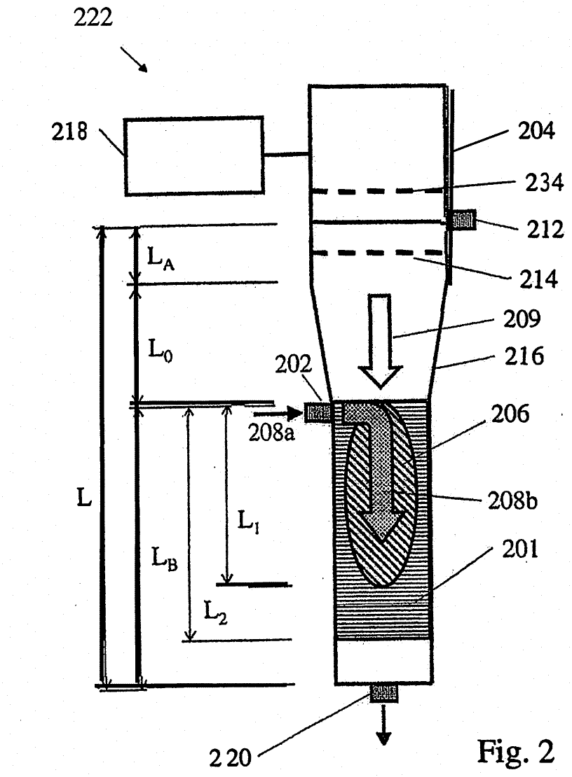

FIG. 2 illustrates embodiments of microwave chemical processing systems of the present disclosure, in which a FEWG is coupled to a microwave energy source. A plasma is generated from a supply gas in a plasma zone of the FEWG, and a reaction length of the FEWG serves as the reaction zone to separate the process material into separate components. The present reactor as demonstrated by FIG. 2 is absent of a dielectric barrier between the field-enhancing zone of the field-enhancing waveguide and the reaction zone. In contrast, the reaction zones of conventional systems, are enclosed within a dielectric barrier such as a quartz chamber. In the embodiment of FIG. 2, the direction of propagation of the microwave energy is parallel to the majority of the flow of the supply gas and/or the process material, and the microwave energy enters the waveguide upstream of the portion of the FEWG where the separated components are generated.

As shown in FIG. 2, a microwave chemical processing reactor 222, in accordance with some embodiments, generally includes a FEWG 216, one or more inlets 202 configured to receive supply gas and/or process material 208a flowing into the FEWG 216, and a microwave energy source 204 that is coupled to the FEWG 216, among other elements not shown for simplicity.

In some embodiments, microwave circuit 218 controls a pulsing frequency at which microwave energy 209 from microwave energy source 204 is pulsed. In some embodiments, the microwave energy 209 from microwave energy source 204 is continuous wave. In some embodiments, the microwave energy source 204 may include an amplifier (such as a klystron or a traveling-wave tube amplifier). In some embodiments, the microwave energy source 204 is integrated with a control circuit, an array of reaction chambers, and a receptacle, all of which may be coupled to each other. The control circuit may control microwave radiation output by the amplifier into the array of reaction chambers to process input raw materials and produce carbonaceous products. In some aspects, the control circuit may include a voltage generator and a pulse generator connected to the voltage generator. The voltage generator may provide a non-zero voltage having a rise time and a fall time to the amplifier. Each of the rise time and the fall time may be between approximately 20 nanoseconds and 50 nanoseconds. The pulse generator may produce a control signal having a pulsing frequency associated with the rise time and the fall time of the non-zero voltage, such that microwave radiation output by the amplifier is based on the control signal. A frequency and a duty cycle of the non-zero voltage may be based on a frequency and a duty cycle of the control signal. The FEWG 216 and each of the reaction chambers may receive the microwave radiation from the amplifier at the pulsing frequency produced by the pulse generator.

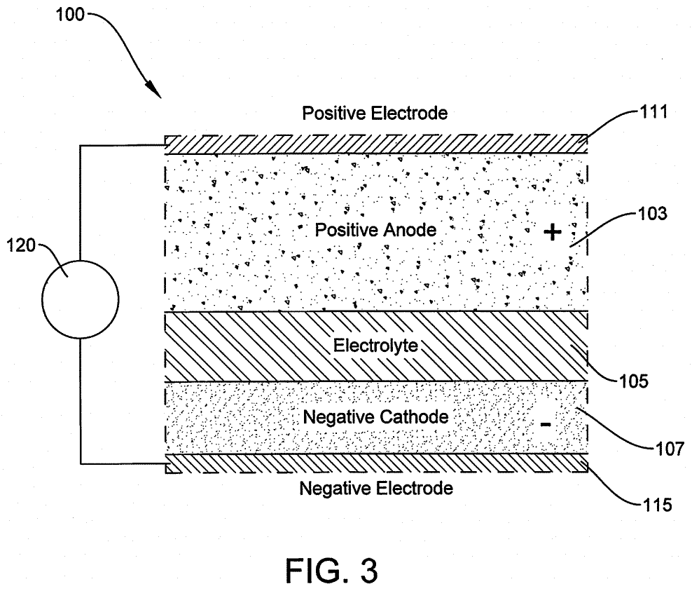

As shown, the FEWG 216 has a length L. The portion of the FEWG 216 with length L_{A} (shown in FIG. 2 and FIG. 3) is closer to the microwave energy source than the portion of the FEWG with length L_{B} (shown in FIG. 2 and FIG. 3). Throughout this disclosure, different portions of the FEWG will be described by a capital L with a subscript denoting the certain portion of the FEWG (e.g., L_{A}, L₀, L_{B}, L₁, L₂), and synonymously, the lengths of the different portions of the FEWG will also be described by a capital L with a subscript denoting the length of a certain portion of the FEWG (e.g., L_{A}, L₀, L_{B}, L₁, L₂).

The cross-sectional area of the FEWG in length L_{B} is smaller than the cross-sectional area of the FEWG in length L_{A}. The length of the FEWG L₀ is located between lengths L_{A} and L_{B} of the FEWG, and has a decreasing cross-sectional area along the path of the microwave energy propagation. In some embodiments, the cross-sectional area of the FEWG along length L₀ decreases in a continuous manner. In some embodiments, the cross-sectional area of the FEWG along length L₀ decreases linearly between lengths L_{A} and L_{B}. In some embodiments, the cross-sectional area of the FEWG along length L₀ decreases non-linearly between lengths L_{A} and L_{B}, such as decreasing parabolically, hyperbolically, exponentially or logarithmically. In some embodiments, the cross-sectional area of the FEWG along length L₀ decreases in a or an abrupt manner between lengths L_{A} and L_{B}, such as decreasing through one or more discrete steps. The decrease in cross-sectional area serves to concentrate the electric field, thus increasing the microwave energy density while still providing a significant amount of area in which plasma can be formed compared to conventional systems. The dimensions of the different portions of the FEWG 216 are set according to the microwave frequency, in order to properly function as a waveguide. The reactors may be scaled up in size as needed, depending on applications requirements.

The microwave energy 209 in FIG. 2 creates a microwave plasma 206 in the supply gas and/or process material within a plasma zone with length L₁ (shown in FIG. 2) of the length of the FEWG 216. The plasma zone with length L₁ is located within the portion of the FEWG L_{B}, where the cross-sectional area is smaller and the microwave energy density is higher than in length L_{A}. In some embodiments, a supply gas that is different from the process material is used to generate the microwave plasma 206. The supply gas may be, for example, hydrogen, helium, a noble gas such as argon, or mixtures of more than one type of gas. In other embodiments, the supply gas is the same as the process material, where the process material is the material from which separated components are being created.

In an embodiment, the supply gas and/or process material inlet 202 is located upstream from the portion of the FEWG L_{B}, or is located within the portion of the FEWG L₀ or is located within the portion of the FEWG L_{A}, or is located upstream of the portion of the FEWG L_{A}. The portion of the FEWG L₁ extends from a position along the FEWG downstream from the position where the supply gas and/or process material 208a enters the FEWG, to the end of the FEWG or to a position between the entrance of the supply gas and/or process material and the end of the FEWG 216. In an embodiment, the portion of the FEWG L₁ extends from where the supply gas and/or process material 208a enters the FEWG, to the end of the FEWG or to a position between the entrance of the supply gas and/or process material and the end of the FEWG.

The generated microwave plasma 206 provides energy for reactions to occur in process material 208b within a reaction zone 201 of the FEWG 216 having a reaction length L₂ In an embodiment, reaction zone L₂ extends from where the process material 208a enters the FEWG 216, to the end of the FEWG 216 or to a position between the entrance of the process material and the end of the FEWG 216. Given the right conditions, the energy in the microwave plasma 206 will be sufficient to form separated components from the process material molecules. One or more outlets 220 are configured to collect the separated products out of the FEWG 216 downstream of the reaction zone portion of the FEWG where reactions occur in the process material 208b. In the example shown in FIG. 2, the propagation direction of the microwave energy 209 is parallel with the majority of the supply gas and/or process material flow 208b and the microwave energy 209 enters the FEWG 216 upstream of the reaction zone 201 of the FEWG where the separated components are generated.

A pressure barrier 234 that is transparent to microwave energy can be located within the microwave energy source 204, near the outlet of the microwave energy source, or at other locations between the microwave energy source 204 and the microwave plasma 206 produced in the FEWG. This pressure barrier 234 can serve as a safety measure to protect from potential backflow of plasma into the microwave energy source 204. Plasma does not form at the pressure barrier itself; instead, the pressure barrier is simply a mechanical barrier. Some examples of materials that the pressure barrier can be made of are quartz, ethylene tetrafluoroethylene (ETFE), other plastics, or ceramics. There can be two pressure barriers 234 and 214, where one or both pressure barriers 234 and 214 are within the microwave energy source 204, near the outlet of the microwave energy source, or at other locations between the microwave energy source 204 and the microwave plasma 206 produced in the FEWG. In some embodiments, the pressure barrier 214 is closer to the microwave plasma 206 in the FEWG than the pressure barrier 234, and there is a pressure blowout port 212 between the pressure barriers 234 and 214 in case the pressure barrier 214 fails.

In an embodiment, a plasma backstop (not shown) is included in the system to prevent the plasma from propagating to the microwave energy source 204 or the supply gas and/or process material inlet(s) 202. In some embodiments, the plasma backstop is a ceramic or metallic filter with holes to allow the microwave energy to pass through the plasma backstop, but preventing the majority of the plasma species from passing through. The majority of the plasma species will be unable to pass the plasma backstop because the holes will have a high aspect ratio, and the plasma species will recombine when they hit the sidewalls of the holes. In some embodiments, the plasma back-stop is located between portion L₀ and L₁ or within portion L₀ upstream of portion L₁ and downstream of the inlet(s) 202 (in an embodiment where an inlet is within portion L₀) and the microwave energy source 204.

In an embodiment, the dissociating reactor 104 incorporates temperature controls, flow controls, and pressure controls to cause intra-reactor conditions such that result in production of only hydrogen gas and carbon solids at the output (e.g., without precipitating any unwanted hydrocarbons, such as benzene and other similar compounds). Such a system is described in U.S. patent application Ser. No. 17/008,188, entitled “Temperature-Controlled Chemical Processing Reactor,” which is assigned to the assignee of the present application, and which is hereby incorporated by reference in its entirety.

The hydrogen gas and the carbon solids can be separated using any known means. Strictly as one example where the separated components include solid particles and gaseous products, a multi-stage gas-solid separator system can be configured to include one or more cyclone separators, and a filter system. In some cases, the one or more secondary cyclone separators filter the carbon particles from the separated components. Some examples of filters include: filters utilizing porous media to capture particles (e.g., pressure filters, vacuum filters, back-pulse filters, etc.), filters utilizing liquids to capture particles (e.g., distillation columns, liquid vortex filters, etc.), and filters utilizing electrostatic forces to capture particles (e.g., electrostatic precipitation filters).

In some embodiments, the temperature of gas-solids separation systems (e.g., the cyclone separators and back-pulse filter system) can also be elevated to prevent gaseous species from condensing on the filters and the produced particles. In some embodiments, the gaseous products are purified after the gas-solids separation system and prior to storage. Although the present embodiments shall be described as using a back-pulse filter, other types of filters may apply to the embodiments.

In typical deployments, a plurality of dissociating reactors are utilized in parallel (e.g., concurrent operation) where each independently-operating dissociating comprises a waveguide; a microwave energy source coupled to the waveguide and configured to propagate microwave energy into the waveguide in a direction parallel to the waveguide, and an inlet configured to flow a material having a hydrocarbon gas in a direction parallel to the microwave energy into the reaction zone. The plasma within the reaction zone is configured to separate the material into a plurality of components, including hydrogen gas and first carbon particles. A gas-solid separator system is coupled to the microwave plasma reactor to receive outputs from the dissociating reactor. In some cases, the material having a hydrocarbon gas comprises any one or more of a natural gas, a biogas, a mixture of natural gas and hydrogen gas, or a mixture of bio-gas a hydrogen gas, methane, ethane, ethylene, acetylene, propane, propylene, butane, butylenes, butadiene, etc.

Further aspects of embodiments are provided in U.S. Pat. No. 10,781,103, entitled “Microwave Reactor System with Gas-Solids Separation,” which is assigned to the assignee of the present application, and which is incorporated herein by reference in its entirety.

FIG. 2 illustrates one example of a dissociating reactor that can be used in system 1A00 and/or system 1B00, and embodiments are not so limited. Any other similar reactor may also be used.

### Hydrogen Production

As shown in FIG. 1A, the dissociating reactor 104 produces hydrogen (H) as one output component. This hydrogen can be used for various different uses, such as to provide the compound for use in hydrogen gas (H₂) filling stations.

In an embodiment, the hydrogen filling station 106A comprises storage and pumping equipment to dispense hydrogen gas by weight for use by hydrogen powered vehicles, engines, machinery, hydrogen fuel cells, and so on. The hydrogen filling station may be a 700 bar (H70) hydrogen filling station or a 350 bar (H35) station, or any other appropriate pressure hydrogen filling station.

For the example embodiment of FIG. 1A, the hydrogen filling station 106A is used to provide gas to a fuel cell electric vehicle 108, though other uses are also possible. Such a vehicle 108 may represent a car, truck, tractor, forklift, motorcycle, tricycle, ATV, or any other motorized self-propelled vehicle that stores on-board fuel to power the motor.

### Carbon Production

As further shown in FIG. 1A, the dissociating reactor 104 produces carbon (C) as the other output component. This carbon can be used for various different uses. In an embodiment, one use of the solid carbon by-product is its use to make fuel cells 110. In general, however, only a relatively small amount of the carbon produced by dissociating reactor 104 is needed to make fuel cells, so the majority of this carbon in used by other carbon applications 112.

Various applications rely on various properties of carbon materials. Strictly as examples, such properties might include mechanical attributes, thermal conductivity, resistance to oxidation, durability, resistance to softening at high temperatures, resistance to fatigue, electrical conductivity, etc. Individual ones and/or combinations of these parameters become dominant when producing a particular carbonaceous material for a particular application.

Strictly as an example, resistance to oxidation might be a dominant parameter when tuning the reactor to produce a solid carbonaceous material for use in making corrosion-resistant valves. As another example, when tuning the reactor particular carbonaceous materials to be used in the manufacture of blades for aircraft engine turbines, mechanical attributes such as a strength-to-weight ratio, subject to a strength minimum constraint might be a dominating mechanical attribute. The blade might also need to exhibit a very high resistance fatigue.

Typically, carbonaceous materials exhibit not only the aforementioned properties but are also less dense than an alternative material (e.g., a metal or alloy). A lower density often corresponds to a lower weight for a formed component as compared with the same component made from the metal or alloy in absence of carbonaceous material loading. As such, truck parts (such as cab components, as shown), automobile parts (such as doors fenders, roof panels, etc.), motorcycle parts, bicycle parts as well as various components (such as structural members) of airborne vehicles, and/or watercraft, and/or space-based vehicles or platforms can avail of the lower weight-to-strength ratio of carbonaceous materials as compared with the base metals or alloys that are used in making the carbonaceous materials.

As another example, carbonaceous materials often exhibit exceptional thermal conductivity such that structural members formed of carbonaceous materials can be used in high-temperature applications (such as heat sinks for electronics, vehicular and/or industrial heat exchangers, etc.).

As yet another example, carbonaceous materials often exhibit exceptional resistance to corrosion. More specifically, certain laminates made using the foregoing carbonaceous materials exhibit extremely high corrosion resistance, even at the top layer (such as at the component-to-environment interface). This property is of particular interest when components made with carbonaceous materials are subjected to harsh environments.

As a still further example, carbonaceous materials can be tuned for surface smoothness. More specifically, laminates made using the foregoing carbonaceous materials exhibit extremely high surface smoothness. This surface smoothness property is of particular interest when the carbonaceous materials serve as a heat shield, such as may be demanded in applications where friction at the surface (such as friction generated as a fluid passes over the surface at high speed) generates unwanted heat at the surface. By using the herein disclosed techniques, the specific composition of the carbonaceous material and/or by using the herein disclosed specific techniques for deposition of the carbonaceous material can result in a hydraulically smooth surface, which can in turn be used in airborne and/or space-based vehicles.

The properties and application as discussed are merely examples. Additional properties and/or combinations of properties might be demanded or desirable in various applications, and these additional properties can be exploited in resultant carbonaceous materials based on tuning of inputs and controls of intra-reactor conditions. Strictly as examples of the foregoing additional properties, such properties and/or combinations of properties might include or be related to a strength-to-weight metric, and/or a specific density, and/or mechanical toughness, and/or sheer strength, and/or flex strength, etc.

### Fuel Cell Production

As shown in FIGS. 1A and 1B, a significant use of the carbon produced by dissociating reactor 104 is in the production of fuel cells 110. Such fuel cells can be used in any type of electric vehicle (EV), such as fuel cell electric vehicles (FCEVs), battery electric vehicles (BEVs), hybrid electric vehicles (HEVs), plug-in hybrid electric vehicles (PHEVs), and/or any other type of vehicle or apparatus that uses fuel cells, and the vehicles may be of any type as mentioned above.

Fuel cells including solid oxide fuel cells (SOFCs) have great potential for providing efficient power generation for industrial, residential, transportation, and military applications. SOFCs convert the fuel's chemical energy directly into electrical energy. The simplicity of SOFC systems provides the potential for high efficiency power generation.

With reference to FIG. 3, the fuel cell 100 has a structure that has a solid flexible electrolyte 105 that is sandwiched between an anode 103 and a cathode 107. Hydrogen H₂ gas is passed through the anode 103 and is split into individual hydrogen H ions and electrons by a catalyst. Oxygen gas O₂ is passed through the cathode 107 that absorbs electrons and creates oxygen ions O²⁻. In solid oxide fuel cells (SOFCs), the oxygen ions O²⁻ pass through the solid flexible electrolyte 105 and combine with the hydrogen H₂ gas to form water H₂O that is expelled from the fuel cell. The electrons pass from the anode 103 to a positive electrode 111 that is coupled to an outer surface of the anode. The electrons flow through an electrical circuit 120 to a negative electrode 115 that is coupled to the cathode 107 that absorbs the electrons.

In the present disclosure, fuel cell components and assemblies made from structured composite materials (SCMs) are described. In different embodiments, the SCMs can contain different combinations of carbon particles that are decorated with conductive particles, electrically conductive materials (ECMs), and/or active materials. In some embodiments, the porous carbon particles provides a structural framework (or scaffold) and the ECM provides high electrical conductivity to the SCM. In some cases, the ECM is decorated on the surfaces and/or in the pores of the carbon particles. The ECMs can form a continuous (or semi-continuous, with some disconnected regions and/or islands) matrix and/or a coating throughout the SCM. In some cases, the porous carbon particles and the conductive particles are coalesced (or, welded together) by decorating an ECM on the carbon particles. The resulting SCMs can contain porous media and conductive particles embedded in a matrix of the ECM. In some cases, the active material is decorated on the surfaces and/or in the pores of the ECM and provides activity (e.g., energy storage capacity) to the SCM.

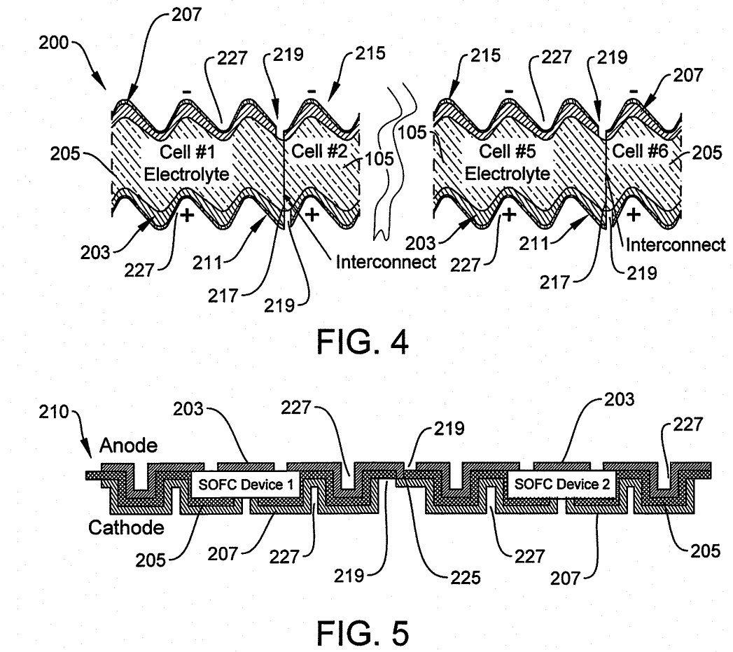

FIG. 4 illustrates an embodiment of a fuel cell structure 200 that has multiple electrically coupled fuel cells by interconnects 217. In the illustrated embodiment, the fuel cells each have a solid flexible electrolyte 205 that has grooved surfaces that are non-planar on opposite surfaces of the electrolyte 205. In the illustrated embodiment, the grooved surfaces on opposite sides of the electrolyte 205 have smooth rounded peaks and valleys that can be configured so that the vertical thickness of the solid flexible electrolyte 205 can be uniform in thickness. A thin anode layer 203 is coupled to a first grooved surface of the electrolyte 205 and a thin cathode layer 207 is coupled to the second opposite grooved surface of the electrolyte 205. A thin anode electrode 211 is coupled to an outer surface of the anode layer 203 and a thin cathode electrode 215 is coupled to an outer surface of the cathode layer 207. The thin anode layer 203, thin anode electrode 211, thin cathode layer 207, and thin cathode electrode 215 can all be uniform in thickness and conform to the grooved surface of the electrolyte 205. The exposed outer surfaces of the thin anode electrode 211 and the thin cathode electrode 215 can also have a grooved surface.

In the illustrated embodiment, the grooved surface configuration of the fuel cell structure 200 can be formed through a process that can include pressing a powdered electrolyte particle material in a mold to form the electrolyte 205. The mold for the press can have grooved surfaces so that the electrolyte 205 is pressed into a solid structure having a grooved anode facing surface and a grooved cathode facing surface. The pressed electrolyte structure can be removed from the press mold and sintered so that the contact points of the adjacent powdered particle material are fused together to create a strong rigid electrolyte structure. The sintering processing can be done with microwave energy applied to the electrolyte 205 which will heat the outer surfaces of the powdered electrolyte particle material partially melt and fuse together at their contact points while the centers of the powdered electrolyte particle material remains cooler and solid. Alternatively, the sintering or any other sintering method such as placing the electrolyte 205 into a sintering furnace. The end result is a solid flexible electrolyte structure.

After the electrolyte 205 has been sintered, an anode material can be spray deposited onto an anode facing side of the electrolyte 205 and a cathode material can be spray deposited onto a cathode facing side of the electrolyte 205. The anode material and the cathode material can be decorated carbon particles such as graphite or graphene that are decorated with different metal materials. The anode layer 203 can be created by spray depositing anode particles onto an anode facing surface of the electrolyte 205 and the cathode layer 207 can be created by spray depositing cathode particles onto a cathode facing surface of the electrolyte 205. Anode electrode materials can be spray deposited onto the exposed surface of the anode layer 203 to form the anode electrode 211 and cathode electrode materials can be spray deposited onto the exposed surface of the cathode layer 207 to form the cathode electrode 215. The spray deposition process can include heating the decorated carbon particles to a molten state and then spraying these semi-solid molten particles with a gas jet towards the solid flexible electrolyte 205. The semi-solid molten particles are sprayed onto the electrolyte 205 and adhere to the electrolyte 205 to form the anode layer 203 and the cathode layer 207 on opposite sides of the electrolyte 205. The anode electrode 215 can then be spray deposited on the anode layer 203 and the cathode electrode 211 can be spray deposited on the cathode layer 207.

This fuel cell structure 200 can then be sintered to fuse the adjacent decorated particles in the anode electrode 215, the anode layer 203, the cathode electrode 211, and the cathode layer 207. The sintering of the adjacent decorated particles can be performed with microwave processing or other sintering methods such as sintering furnaces. The finished fuel cell structure 200 can have grooves 227 in the exposed anode electrodes 215 and the cathode electrodes 211.

The illustrated fuel cell structure 200 has six distinct and separate fuel cells that are electrically coupled in series. Each fuel cell can have a voltage output V. and the voltage output of the fuel cell structure 200 can be cumulative, where the total fuel cell assembly voltage output=Vₒᵤₜₚᵤₜ=V₁+V₂+V₃+V₄+V₅+V₆. The series configuration can be important because the voltage output of each cell can be very low. For example, the voltage output for each fuel cell can be between about 0.2-2.0 volts. Most electrical equipment does not operate at such a low voltage and therefore a higher voltage source can be necessary for providing electrical power to electrical equipment. By configuring the fuel cells in series, the voltages for each fuel cell are added. For example, if V₁, V₂, V₃, V₄, V₅, and V₆ each=2 volts direct current (DC) and are coupled in series, then the fuel cell assembly output voltage, the Vₒᵤₜₚᵤₜ would be 12 volts which is a much more common and useful voltage power supply. Power in Watts (P)=Volts (V)×Amps (A). Therefore, if the power output of each fuel cell is 1 kW with an output voltage of 2V, the current produced by each fuel cell is 500 A. Because the fuel cells are coupled in series, the current produced by the fuel cell structure 200 will be 500 A. In other embodiments, the fuel cell structure 200 can have any number of fuel cells that can be electrically coupled in series and/or in parallel.

The thin anode layer 203 and thin anode electrode 211 can cover the anode facing surface of the solid flexible electrolyte 205. The thin cathode layer 207, and thin cathode electrode 215 can cover the cathode facing surface of the electrolyte 205. However, each fuel cell has a separate anode, anode electrode, cathode, and cathode electrode. An isolation 219 is placed between the adjacent thin anode layers 203, thin anode electrodes 211, thin cathode layers 207, and thin cathode electrodes 215 of the adjacent fuel cells. The isolation 219 are non-conductive and can be an open gap or an insulative non-conductive material between the adjacent thin anode layers 203, thin anode electrodes 211, thin cathode layers 207, and thin cathode electrodes 215.

In the illustrated embodiment, the adjacent fuel cells are electrically coupled to each other in a sequential manner by interconnect conductors 217 that extend through the thickness of the solid flexible electrolytes 205. The interconnect conductors 217 electrically connect the anode electrode 211 of a fuel cell to the cathode electrode 215 of an adjacent fuel cell. The interconnect conductors 217 can be formed by etching holes through the thickness of the solid flexible electrolytes 205 and then depositing or inserting a conductive material in the etched holes to electrically couple the anode electrodes 211 to the cathode electrodes 215.

In the illustrated embodiment, the interconnect conductors 217 connect the anode electrode 211 of a fuel cell #1 to the cathode electrode 215 of adjacent fuel cell #2. The center fuel cells #3 and #4 of the fuel cell structure 200 is not illustrated. The interconnect conductors 217 between the anode electrode 211 of fuel cell #5 and the cathode electrode 215 of a fuel cell #6 are illustrated. While the illustrated configuration shows the interconnect conductors 217 passing through a portion of the electrolyte 205, in other embodiments, the interconnect conductors 217 can be electrical conductors that extend around a side of the electrolyte 205 to electrically couple the anode electrode to the cathode electrode of an adjacent fuel cell.

FIG. 5 illustrates another embodiment of a fuel cell assembly 210 that has more rectangular cross section grooves 227 than the rounded cross section grooves 227 in the fuel cell assembly illustrated in FIG. 4. The rectangular grooves 227 can provide more surface area than rounded cross section grooves and therefore rectangular cross section grooves 227 can be more efficient than rounded cross section grooves. However, a fuel cell assembly 210 with rectangular grooves 227 may require special design considerations. It can be very difficult to remove pressed electrolyte structures from electrolyte molds having sharp corners and thin protruding features. A basic consideration in designing an electrolyte mold with rectangular grooves 227 is to avoid sharp corners in the mold groove design. Other limitations of molded fuel cell components can be a maximum surface area below 20 square inches (0.013 m²) and a height-to-diameter ratio of the grooves that is below 7-to-1 The walls that form the grooves in the fuel cell components may also need to be thicker than 0.08 inches (2.0 mm). The adjacent wall thickness ratios may be below 2.5-to-1. By following these mold design guidelines, fuel cell components with rectangular grooves 227 can be fabricated through molding processing.

In some embodiments, the fuel cell assembly 210 can be fabricated with a process that can include fabricating fuel cell such as the solid flexible electrolyte with planar surfaces and then etching or machining the planar surfaces to create the grooved surfaces and the isolations between the adjacent anodes 203 and cathodes 207, and holes for the interconnects between the anodes 203 and cathodes 207 of the adjacent fuel cells. A conductive material can then be deposited in the holes to form the interconnects between the anodes 203 and cathodes 207 of the adjacent fuel cells. In alternative embodiments, the grooved surfaces on the fuel cell components can be formed with a process that can include patterned material deposition on planar surfaces of the fuel cell components to create the grooved surfaces.

In an embodiment, the solid flexible electrolyte 205 can be made of electrolyte particles that are pressed into a three dimensional structure having two opposite surfaces that will become the anode facing surface and the cathode facing surface. The planar surfaces of the electrolyte 205 can then be etched or machined to form grooves with vertical sidewalls. The electrolyte 205 can also be etched, machined, or drilled through the entire thickness of the electrolyte 205 at the borders 225 of the adjacent fuel cells to form interconnect conductor holes. Various methods can be used to remove material from the electrolyte including: laser etching, electro-etching, electrochemical etching, micro-machining, drilling, etc.

The electrolyte 205 can be sintered to fuse the electrolyte particles at their contact points and form a high strength solid flexible electrolyte 205 structure. In some embodiments, the anode layer 203 can be spray deposited onto the grooved anode facing surface of the electrolyte 205 and the cathode layer 207 can be spray deposited onto the grooved cathode facing surface of the electrolyte 205. In the illustrated embodiment, the anode layer 203 material can fill the etched portions of the electrolyte 205 at the borders 225 of the adjacent fuel cells. Once the anode layer 203 and the cathode layer 207 are deposited on the electrolyte 205, these surfaces can be etched to create gaps 219. The anodes 203 of the adjacent fuel cells are separated by isolations 219 that can be non-conductive and can be open gaps or insulative materials in the open gaps and the cathodes 207 of the adjacent fuel cells are also separated by non-conductive isolations 219. The anode layer 203 and the cathode layer 207 can also be etched to form the grooves 227 that have vertical side walls.

In this embodiment, the anode electrodes can be integrated into the anode 203 structures and the cathode electrodes can be integrated into the cathode 207 structures. The anode layer 203 can be electrically connected to the cathode layer 207 at the borders 225 of the adjacent fuel cells so that the adjacent fuel cells are electrically connected in series. The right end of the anode 203 of the first fuel cell is electrically coupled to the left end of the cathode 207. In some embodiments, solid flexible electrolytes 205 can be etched through the entire thickness at the borders 225 before the anode layer 203 or the cathode layer 207 are deposited so that an electrical connection between the anode layer 203 and the cathode layer 207 can be formed when these layers are deposited. In the illustrated embodiment, the right edge of the anode 203 of the left fuel cell separates the solid flexible electrolytes 205 of the two adjacent fuel cells. In other embodiments, the anode layer 203 can be coupled to the cathode layer 207 with an electrical interconnect that extends around the side of the fuel cell 210.

The illustrated fuel cell assembly 210 includes two fuel cells that each include: a solid flexible electrolyte 205, an anode 203 and a cathode 207. If the power output of each fuel cell is 500 W with an output voltage of 3 V, then the total voltage output would be 6 V and the current output would be 250 A.

As discussed above, the anode layer, anode electrode layer, cathode layer, and cathode electrode layer can be spray deposited. “Thick-film” technologies, that do not require a vacuum for deposition, can be used for the spray deposition to deposit the anodes, anode electrodes, cathodes, and cathode electrodes in one or more deposited layers. Each deposited thick film layer can be between about 0.0001 to 0.1 mm in thickness. A benefit to patterning these thick film materials with etch processing is the ability to create multiple cells on one substrate. A large anode layer can be deposited on an anode facing side of the electrolyte and a large cathode layer can be deposited on a cathode facing side of the electrolyte. In order to form multiple fuel cells, portions of the anode and cathode layers can be removed to create separate and distinct anode and cathode layers for each fuel cell formed on the common solid flexible electrolyte substrate. The process for removing portions of the anode and cathode layers can include: laser etch, chemical etch, micromachining, or any other suitable processing.

By coupling the multiple fuel cells in series, the low voltage output of each of the individual fuel cells can be combined to a higher more useful voltage such as five or more volts. Because the fuel cells are on the same substrate, the multiple fuel cells can occupy the same physical footprint as a prior art single fuel cell that would have a much lower voltage output. This more compact multiple fuel cell assembly structure can ease the integration of the inventive fuel cell assembly into real world devices, at a greatly reduced cost. This inventive multiple fuel cell assembly has the potential to save as much as 75% of the energy and time to fabricate compared to known fuel cell fabrication processes. The inventive multiple fuel cell assembly can also greatly reduce the overall carbon footprint because methane can be processed in a reactor to create hydrogen fuel (used for fuel in the fuel cell) and solid carbon particles (used in the manufacture of the solid flexible electrolyte). In some embodiments, the plurality of carbon particles are produced in a first region of a reactor, and the depositing or decorating of the carbon particles with an electrically conductive material occurs in a second region of the reactor. The first and the second regions of the reactor can be arranged such that the porous carbon particle media exits the first region of the reactor and enters the second region of the reactor without being exposed to an environment containing more than 100 ppm of oxygen. The hydrogen produced by the reactor can be used to power the inventive fuel cells. The only emission from the fuel cells is water so there is only consumption of carbon rather than emission of carbon. This innovation enables the low-cost, high-volume fuel cell production needed for market adoption of fuel cell technology.

One of the factors that influence the efficiency and output of a fuel cell is the 3 phase reaction boundary layer which is the interface area between the cathode layer 207 and the solid flexible electrolyte 205. For fuel cells, the 3 phases are: an ion conductor electrolyte, an electron conductor, and a virtual “porosity” phase for transporting gaseous fuel molecules. The electrochemical reactions that fuel cells use to produce electricity occur in the presence of the 3 phases at the 3 phase reaction boundary layer. The oxygen reduction reaction that occurs at the 3 phase reaction boundary layer which is the cathode and electrolyte interface, can be written as Table 1:

TABLE 1

| Reaction | Equation |
|---|---|
| Anode reaction | 2H₂ (gas) + 2O²⁻ (gas) → 2H₂O (gas) + 4e⁻ |
| Cathode reaction | O₂ (gas) + 4e⁻ → 2O²⁻ (gas) |
| Overall cell reaction | 2H₂ (gas) + O₂ → 2H₂O (gas) |

Increasing the 3 phase reaction boundary layer surface area will increase the electro-chemical reaction rate, and thus increase cell performance. The 3 phase reaction boundary power output density will also be influenced by the kinetics of the oxidation reaction that occurs between oxygen ions and fuel on the anode layer of the fuel cell. The efficiency and output of a fuel cell can be proportional to the 3 phase boundary layer area so that a fuel cell with a larger 3 phase boundary layer area will be more efficient and have a higher electrical output than a fuel cell with a smaller 3 phase boundary layer area. One way to increase the area is to have a 3 phase boundary layer area that is a non-planar grooved surface rather than a flat planar area.

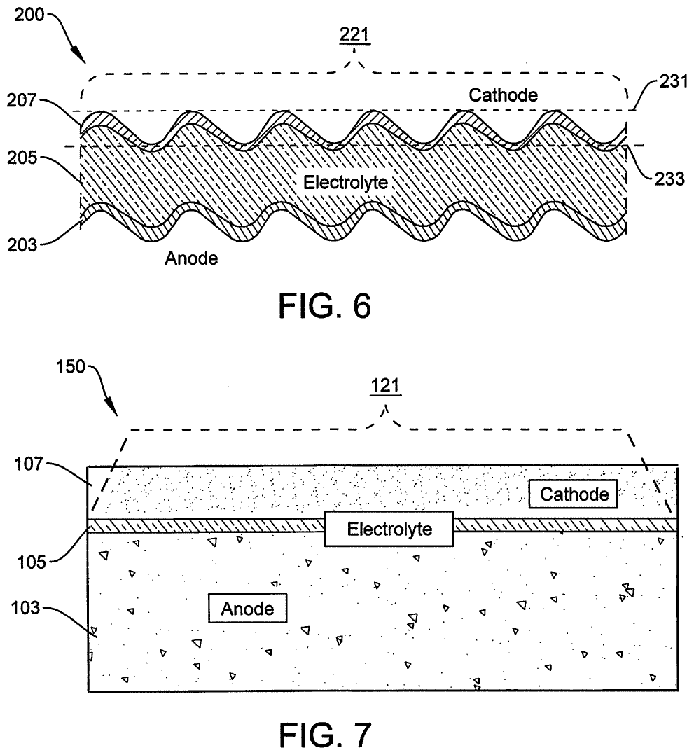

An embodiment of a fuel cell structure 200 having a grooved 3 phase reaction boundary layer surface is illustrated in FIG. 6 and an embodiment of a fuel cell assembly 150 having a planar 3 phase reaction boundary layer surface is illustrated in FIG. 7. With reference to FIG. 6, because the grooved 3 phase reaction boundary area 221 is substantially larger than planar 3 phase reaction boundary area, a fuel cell 200 having a grooved 3 phase reaction boundary area 221 will have a higher power output than a fuel cell assembly 150 that has planar 3 phase reaction boundary area. In the illustrated embodiment, the grooves 227 can have peaks 231 and valleys 233 that are uniform so that each of the grooves 227 has a uniform depth.

The increase in 3 phase reaction boundary area 221 can be proportional to the depth from the peaks 231 to the valleys 233 and the distance between the peaks 231. In the illustrated embodiment, the depth of the valleys 233 is approximately 50% of the distance between the adjacent valleys 233. The angles formed by the peaks and valleys can be approximately 90 degrees with each surface of the grooved 3 phase reaction boundary area 221 being approximately 45 degrees. The grooved 3 phase reaction boundary area 221 can be formed by pressing the electrolyte particles in an electrolyte mold that has patterned groove surfaces. The surface area between each of the adjacent peaks 231 can be roughly calculated as (distance between peaks)/(cosine valley angles). For example, if the distance between peaks is 1 millimeter and the angle of the valleys is 45 degrees, the distance between the adjacent peaks across the valley is 1 millimeter/(cosine 45 degrees)=1.41 millimeters representing a 41% increase in surface area of the 3 phase reaction boundary area 221. Steeper valley angles can result in deeper grooves and higher increases in the 3 phase reaction boundary area 221.

As discussed above with reference to FIG. 5, in other embodiments, the 3 phase reaction boundary area can have a pattern of rectangular grooves that can be formed through a chemical etching, laser etching, micromachining, or other suitable process. The surface area of these rectangular grooves can be roughly calculated by adding the surface areas of side walls of the grooves. The surface area of the grooved surface can be (the distance between the adjacent peaks)+2 (the depth of grooves). If the depth of the grooves is 50% of the distance between the adjacent peaks, then surface area is effectively doubled. For example, if the distance between the adjacent peaks is 10 millimeters and the depth of the grooves is 5 millimeters, then the total surface area of each rectangular groove is 20 millimeters. Deeper grooves will result in higher 3 phase reaction boundary areas.

Micromachining is a manufacturing technology that involves the use of mechanical micro tools with geometrically defined cutting edges in the subtractive fabrication of devices or features with at least some of their dimensions in the micrometer range. Micromachining techniques include bulk micromachining that includes selective etching, surface micromachining that builds a surface layer deposited on a surface. Micromachining can used to form the surface grooves and interconnections on the fuel cell assembly.

Patterning the solid flexible electrolyte material increases the active surface area of the triple phase boundary density per fuel cell and can also reduce the overall thickness of the electrolyte. The patterned grooved features on anode facing surface and cathode facing surface of the electrolyte can be formed in various different ways. In an embodiment, the electrolyte particles can be compressed in a mold having the desired patterned grooved surfaces. In another embodiment, the anode facing and cathode facing surfaces of the electrolyte can be exposed to a micro-abrasion media that can create the patterned grooved features. In yet another embodiment, the anode facing and cathode facing surfaces of the electrolyte can be exposed to laser patterning that can cut the patterned grooved features.

Thermal Expansion

A common failure mode for fuel cells is delamination at the component layer interfaces, i.e., the interface area of the anode to the solid flexible electrolyte and the interface area of the cathode to the solid flexible electrolyte. Each component layer can be made of a different material that can each have a different coefficient of thermal expansion (CTE), so each component expands at a different rate when heated. The patterned grooved features formed on the electrolyte, anode, anode electrode, cathode, and cathode electrode described above, can also mitigate delamination failures due to the different material layers of the fuel cell having different coefficients of thermal expansion.

When operating, fuel cell temperatures rise to 400° C.-1,000° C., causing the anode, cathode, and solid flexible electrolyte all to expand. The difference in expansion rates creates stress between the anode and the electrolyte and between the cathode and the electrolyte, eventually causing delamination. When operating, the fuel cell temperatures can rise from ambient to 400° C.-1,000° C. and the different layers will expand according to the thermal expansion equation, ΔL=αL ΔT, where ΔL is the change in length L due to thermal expansion, a is the coefficient of linear thermal expansion, and ΔT is the change in temperature. If each of the different solid flexible electrolyte, anode, anode electrode, cathode, and cathode electrode layers of the fuel cell have the same α coefficient of linear thermal expansion, then each layer will expand the same amount for any change in temperature and there will not be any strain between the adjacent layers of the fuel cell.

In an embodiment, the a coefficients of thermal expansion are relatively close in value so that the strain between the adjacent layers of the fuel cell will be well below the bonding strengths of the adjacent layers. For example, the a coefficient of thermal expansion of the anode layer or the cathode layer can be within 5% of the a coefficient of thermal expansion of the solid flexible electrolyte.

Another way to avoid delamination is have flexible anode and cathode layers. The flexibility of the fuel cell assembly layers can depend on layer thickness. Generally, a thicker layer will result in a less flexible layer. Thinner layers can be flexible while also being tough and hard and suitable for the mechanical and thermal requirements of fuel cells. The deposited sintered layers of the fuel cell can be structures with a flexibility sufficient to permit a high degree of bending without breakage under an applied force and a high degree of thermal expansion without delamination.

Thus, a way to reduce the rigidity of the fuel cell components can be to reduce the thicknesses of the anode and cathode layers. By using thinner anode and cathode layers, these layers will be more flexible and can absorb the strain at the interfaces with the solid flexible electrolyte even if there is a substantial difference between the a coefficient of thermal expansion of the anode layer or the cathode layer and the a coefficient of thermal expansion of the electrolyte. These thinner anode and cathode layers can decrease the effect of the differences in the coefficients of thermal expansion mismatch, increasing the longevity of the fuel cell.

In yet another embodiment, the anode layer and/or the cathode layer the fuel cell assembly can be placed on the solid flexible electrolyte through “roll-to-roll processing.” The anode and cathode layer materials can be stored on a roll. The anode and cathode can be unrolled and the electrolyte can be placed against the unrolled portions of the anode layer material and the cathode layer material. The anode layer material and the cathode layer material can be bonded to the electrolyte and the anode layer material and the cathode layer material can be cut away from their respective rolls. Because the anode and cathode materials are flexible, anode and cathode layers will conform to the grooved surfaces of the electrolyte. The anode and cathode can be unrolled and a new electrolyte can be placed against the unrolled portions of the anode layer material and the cathode layer material.

In some embodiments, the form factor of the fuel cell can be produced on the order of standard macro-size form factor, or it may be formed into a micro-size form factor on the size order of a household battery. Any appropriate size, scale, shape, or configuration may be used, depending on application constraints and requirements.

If the different fuel cell layers have different a coefficient of thermal expansion, then each layer will expand by different amounts when the temperature of the fuel cell changes from ambient to an operating temperature of 400° C.-1,000° C. These differences in expansion will result in shear forces between the layers that can result in delamination failure of the fuel cell if the thermal expansion shear forces exceed the bonding strength of the adjacent layers. A fuel cell having a grooved pattern surface interface surfaces between the adjacent layers of the fuel cell can be more tolerant to thermal expansion than a fuel cell with planar layer interfaces.

The peaks and valleys of the grooved patterned interface can function as “expansion loops” that can accommodate the different thermal movements of the different fuel cell layers. Although layers of the fuel cell are semi-rigid, the grooved patterned interfaces will allow for more relative movement of the adjacent layers than a fuel cell having planar layers and planar interfaces. The peaks and valleys of the grooved patterned interface can reduce the stress loads on the interface of the adjacent layers of the fuel cell. The expansion of the different layers can result in very small changes in the angles between the peaks and valleys of the patterned grooved surface which is less likely to result in delamination than a fuel cell having adjacent layers that have planar interfaces.

The maximum power output of a fuel cell can be proportional to the area size of the 3 phase reaction boundary area. The surface area can be increased by forming grooves on the 3 phase reaction boundary area. For example, the grooved 3 phase reaction boundary area can provide three times as much surface area compared with fuel cells that have a planar 3 phase reaction boundary area for the same fuel cell size. By using a grooved 3 phase reaction boundary area in the fuel cell, the power output can be two times higher for substantially the same size fuel cell. In other words, the inventive fuel cell can have two times the power density compared to known fuel cells due to the larger 3 phase boundary surface area. Because of this larger grooved 3 phase reaction boundary area 221, the fuel cell 200 shown in FIG. 6 can output two times the power output of the fuel cell assembly 150 with the planar 3 phase reaction boundary area 121.

FIG. 7 illustrates an embodiment of a fuel cell assembly 150 that has an anode 103, a cathode 107, and a solid flexible electrolyte 105 that have planar surfaces. In this embodiment, the 3 phase reaction boundary area 121 at the interface of the cathode 107, and the solid flexible electrolyte 105 is also planar. The power output density of the fuel cell assembly 150 can be proportional to the 3 phase reaction boundary area. For fuel cells having the same physical size, a grooved 3 phase reaction boundary area 221 shown in FIG. 6 will have a larger 3 phase reaction boundary area and a larger higher power output density than a planar 3 phase reaction boundary area 121 shown in FIG. 7. In some embodiments, the grooved 3 phase reaction boundary area 221 shown in FIG. 6 may have a surface area that is up to three times larger than the 3 phase reaction boundary area 121 shown in FIG. 7.

The components of the inventive fuel cells can be fabricated from carbon particles such as graphene or carbon nano-onions that can be decorated with conductive materials. Graphene is an allotrope of carbon consisting of a single layer of atoms arranged in a lattice. Graphene has a high tensile strength and high electrical conductivity and is the thinnest two-dimensional material. Carbon nano-onions can be multi-layer fullerenes that are carbon atoms connected by single and double bonds so as to form a closed or partially closed mesh, with fused rings of five to seven atoms. The molecule may be a hollow spherical shape having multiple onion layers of carbon.

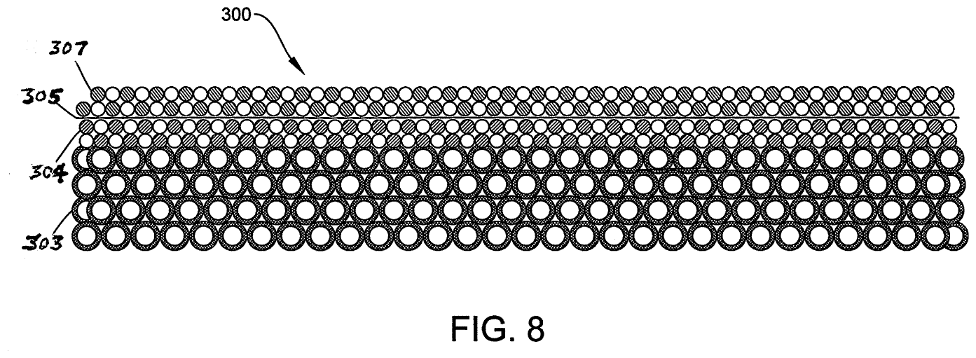

FIG. 8 illustrates an embodiment of a fuel cell 300 that more clearly illustrates the carbon particle configuration. Each carbon particle is illustrated as a circular structure that has a conductive material decoration. Electrolyte particles can be pressed and sintered to a required porosity and density. The electrolyte particles can be pressed in a mold to form the electrolyte layer 305. The electrolyte layer 305 can be removed from the mold and exposed to microwaves to sinter the electrolyte layer 305 to fuse the adjacent electrolyte particles at their contact points.

Cathode particles are deposited on a cathode facing side of the electrolyte 305 to form a cathode layer 307. The cathode particles can be carbon particles that are decorated with a cathode conductive material. In some embodiments, the cathode layer 307 can be spray deposited onto the cathode facing side of the electrolyte 305. The cathode layer 307 can be sintered to fuse the adjacent cathode particles at their contact points.

Functional anode particles are deposited on an anode facing side of the electrolyte 305 to form a functional anode layer 304. The functional anode particles can be carbon particles that are decorated with a functional anode conductive material. Anode particles are deposited on the exposed surface of the functional anode layer 304. The anode particles can be carbon particles that are decorated with an anode conductive material. The functional anode layer 304 can be spray deposited onto the anode facing side of the electrolyte 305 and the anode layer 303 can be spray deposited onto the functional anode layer 304. The functional anode layer 304 and the anode layer 303 can be microwave sintered so that the particles are fused together at their contact points.

In addition to sintering, microwave energy can also be used to perform other fuel cell process steps. For example, microwave energy can be used to alter and control the porosity and density of the fuel cell components. Higher heat and longer exposure will result in more melting and fusing of the materials which can result in lower porosity and higher density. The microwave energy processing can also be used to anneal the fuel cell components.

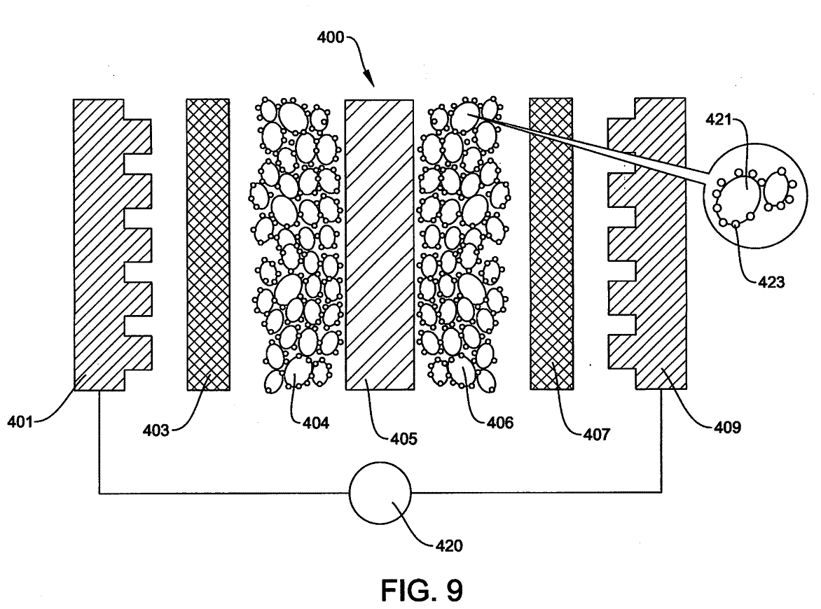

FIG. 9 illustrates another embodiment of a fuel cell 400 having an anode separator 401, an anode gas diffusion layer 403, an anode catalyst layer 404, a solid flexible electrolyte membrane 405, a cathode catalyst layer 406, a cathode gas diffusion layer 407, and a cathode electrode separator 409. One or more of the fuel cell 400 components of the fuel cell 400 can be formed from metal decorated graphene. The fuel cell 400 components include: an anode separator 401, an anode gas diffusion layer 403, an anode catalyst layer 404, a solid flexible electrolyte membrane 405, a cathode catalyst layer 406, a cathode gas diffusion layer 407, and a cathode electrode separator 409. Each of the fuel cell 400 components can have a different metal decoration, porosity, and density.

On the anode side of the fuel cell 400, a fuel gas source can be coupled to the anode electrode separator 401 that can have a grooved surface that forms flow passages for the fuel gas that can be hydrogen gas. The fuel gas can flow from a fuel source through the grooves of the anode electrode separator 401 to the anode gas diffusion layer 403. The anode gas diffusion layer 403 can facilitate uniformity of the fuel gas flow to the anode catalyst layer 404 so that the fuel gas is evenly distributed and can flow evenly through the anode catalyst layer 404. The anode catalyst layer 404 can accelerate the chemical reaction on the fuel anode.

On the cathode side of the fuel cell 400, ambient oxygen gas can flow through the cathode electrode separator 409 that can have a grooved surface that forms flow passages for the oxygen gas into the fuel cell 400. The oxygen gas can flow through the grooves of the cathode electrode separator 409 to the cathode gas diffusion layer 407. The cathode gas diffusion layer 407 that can homogenize the oxygen gas flow to the cathode catalyst layer 406 so that the oxygen gas is evenly distributed and can flow evenly through the cathode catalyst layer 406. The cathode catalyst layer 406 can accelerate the chemical reaction on the air cathode.

In a solid oxide fuel cell configuration, the solid flexible electrolyte membrane 405, oxygen ions can allow oxygen ions (O²⁻) from the cathode catalyst layer 406 to permeate through the electrolyte membrane 405 and combine with the hydrogen from the fuel anode catalyst layer 404 forming water. At the same time, electrons flow from the anode electrode separator 401 to the cathode electrode separator 409 through an external circuit, producing direct current electricity.

In other configurations, the solid flexible electrolyte membrane 405 can allow oxygen ions (O²⁻), to move between the anode catalyst layer 404 and cathode catalyst layer 406 sides of the fuel cell 400. At the anode catalyst layer 404 a catalyst causes the hydrogen fuel to undergo oxidation reactions that generate positively charged hydrogen ions and electrons. The hydrogen ions can move from the anode side to the cathode side through the electrolyte membrane 405 and at the cathode catalyst layer 406, another catalyst causes the hydrogen gas to form hydrogen ions (protons) and electrons. The hydrogen ions react with the oxygen forming water. At the same time, electrons flow from the anode electrode separator 401 to the cathode electrode separator 409 through an external circuit 420, producing direct current electricity.

The anode gas diffusion layer 403 can also control the H₂O (steam and/or water) flow that can maintain the H₂O content of the fuel cell 400 to a suitable level. More specifically, the anode gas diffusion layer 403 can remove by-produced water outside of the anode catalyst layer 404 and prevent flooding while keeping some water on surface for conductivity through the solid flexible electrolyte membrane 405. The anode gas diffusion layer 403 can also provide heat transfer during cell operation to remove the heat from the electrolyte membrane 405 during operation.

The three dimensional components of the fuel cell 400 can be made from homogeneous metal decorated graphene. This construction can enable various benefits. The homogeneous metal decorated graphene fuel cell components are more robust throughout the stack of the assembly creating a more durable and stronger fuel cell 400. The solid flexible electrolyte created from graphene particles decorated with chitosan can create a proto-exchange membrane fuel cell that produce a much higher power density. A proto-exchange membrane electrolyte created from graphene decorated with chitosan can increase proton conductivity by more than 500% compared to electrolytes created from pure chitosan. A proto-exchange membrane electrolyte created from graphene decorated with chitosan can also be less expensive than electrolytes created from pure chitosan. The enhanced proton conductivity of the electrolyte due to the graphene decorated with chitosan construction results in a fuel cell having a higher power density.

The configuration of the fuel cell 400 can provide various functional benefits. The cathode gas diffusion layer 407 can help to control the water flow to maintain water content of the fuel cell 400 to a suitable level. More specifically, the anode gas diffusion layer 403 can remove water produced by the anode catalyst layer 404 and prevent flooding while keeping some water on surface for conductivity through the electrolyte membrane 405. The anode gas diffusion layer 403 can also provide heat transfer during cell operation to remove the heat from the electrolyte membrane 405 during operation.

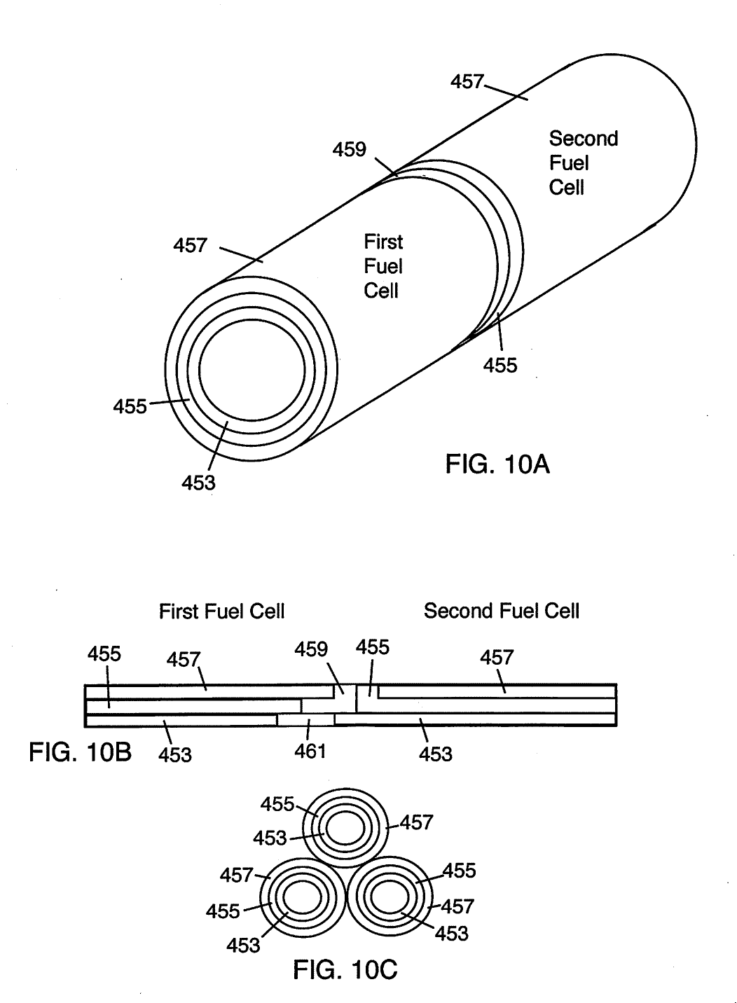

The fuel cells have been described as flat structures with multiple substantially planar component layers. In other embodiments, fuel cell construction can be fabricated that can have a tubular or cylindrical structure. FIG. 10A illustrates a perspective view of a cylindrical fuel cell assembly having tubular anodes 457, electrolytes 455, and cathodes 453. The solid flexible electrolytes 455 can be fabricated from electrolyte particles that are pressed in a tubular mold and exposed to microwaves that burn off binder materials and sinter the adjacent electrolyte particles to create the cylindrical electrolytes 455. The cathode layers 453 can be spray deposited on the inner surfaces of the solid flexible electrolytes 455 and the anode layers 457 can be spray deposited on the outer surfaces of the solid flexible electrolytes 455. The cathode layers 453 and the anode layers 457 can be exposed to microwaves that burn off binder materials and sinter the adjacent anode and cathode particles to create a tubular or cylindrical fuel cell.

During operation of the tubular fuel cell, hydrogen gas fuel can pass over the outer surfaces of the fuel cell and through the porous anode layer 457 to the electrolyte 455. Air can flow through the center orifice and oxygen can pass through the porous cathode layer 453 to the electrolyte 455. Oxygen ions (2O²⁻) can pass through the solid flexible electrolyte 455 and combine with the hydrogen (H) to form water (H₂O). Electrical energy is generated between the anode layer 457 and the cathode layer 453.

With reference to FIGS. 8A and 8B, in some embodiments, multiple fuel cells can be constructed in series on the same single tubular fuel cell assembly. In the illustrated example, the cathode layers 457 of the two adjacent fuel cells can be separated by interconnects 459 and electrolytes 455. FIG. 10B illustrates a cross section of a portion of the tubular two fuel cell assembly. The interconnects 459 can electrically couple the anode layer 457 of a first fuel cell to the cathode layer 453 of a second adjacent fuel cell. The interconnects 459 can also separate the adjacent electrolytes 455 of the adjacent fuel cells. The insulators 461 can separate the cathode layers 457 of the adjacent fuel cells. The material removal and deposition of the components of the illustrated tubular fuel cell assembly can be processed through micromachining or other etching processes such as laser material removal. While two fuel cells are illustrated in this example, in other embodiments, any number of fuel cells can be assembled and coupled in series in the same tubular assembly structure.

Multiple tubular fuel cell assemblies can also be arranged in a parallel configuration. With reference to FIG. 10C, three tubular fuel cell assemblies are arranged in parallel. The tubular fuel cell assemblies can be electrically coupled in series to increase the cumulative voltage output or alternatively, the tubular fuel cell assemblies can be electrically coupled in parallel. As discussed, fuel cells can have a lower voltage output therefore electrically coupling the fuel cells in series can increase the cumulative voltage output to a level that is compatible with more electrical devices.

The anode catalyst layer 404 and the cathode catalyst layer 406 are illustrated as carbon particles 421 that are decorated with conductive materials 423. The anode catalyst layer 404 and the cathode catalyst layer 406 can be spray deposited onto opposite sides of the solid flexible electrolyte. The anode catalyst layer 404 and the cathode catalyst layer 406 can then be sintered. In some embodiments, the sintering can be performed with micro-wave energy. The conductive materials 423 on the carbon particles 421 can be heated and fused together at their contact points during the sintering process. The anode catalyst layer 404 and the cathode catalyst layer 406 can have a higher porosity and a lower density than the other components of the fuel cell 400.

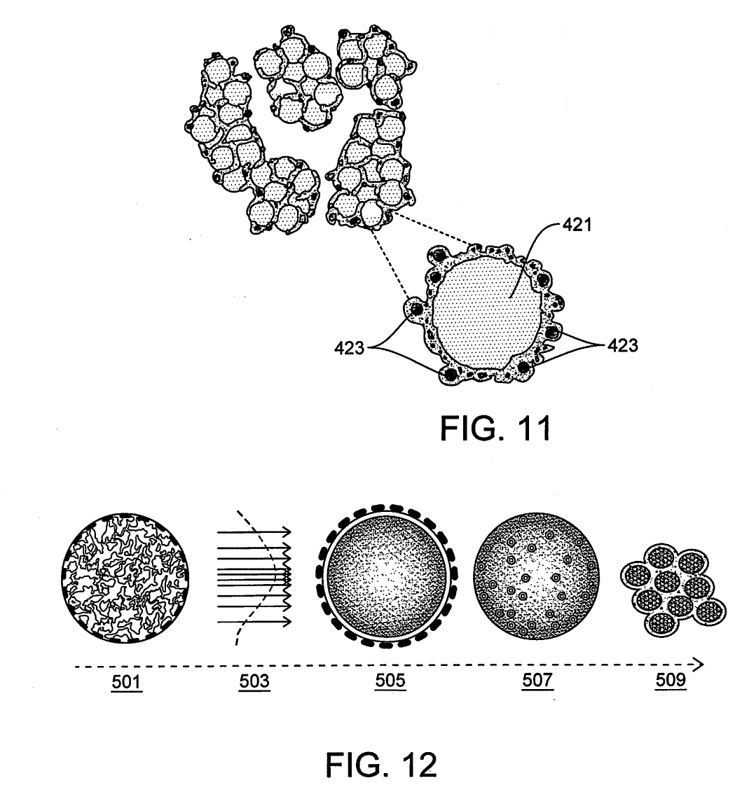

In different embodiments, some or all of the fuel cell components can be built with three dimensional metal decorated carbon particles. With reference to FIG. 11, carbon particles 421 decorated with conductive materials 423 are illustrated. The carbon graphene particles 421 can be granular materials that are each discrete solid structures. The conductive materials 423 are much smaller than the carbon particles 421 and are attached to the outer surfaces of the carbon particles 421.

The initial carbon particles can be a porous media with a larger diameter (e.g., 10 microns, or 1 micron), and these particles can be broken during formation of the SCM such that the porous carbon media particle size is smaller (e.g., less than 1 micron, or less than 100 nm) in the formed SCM. The porous media can be any shape that provides a high porosity, such as mesoporous structures or hierarchical structures (i.e., structures with small and large features).

The SCMs can contain different combinations of porous media, conductive particles, electrically conductive materials (ECMs), and/or active materials. An ECM can be conformally decorated (e.g., deposited, coated) on the surfaces and/or within the pores of the carbon particle media. In some embodiments, the SCMs containing the porous media and the ECM, can have an electrical conductivity greater than 500 siemens per meter (S/m), or greater than 2,000 S/m, or from 500 S/m to 5,000 S/m, or from 500 S/m to 20,000 S/m. In some cases, the electrical conductivity of the SCMs is measured after compression, sintering, and annealing. In some embodiments, the SCMs containing the porous media and the ECM, as described above, have an electrical sheet resistance less than 1 ohm/square, or less than 100 Ohm/square, or between 1 Ohm/square and 100 Ohm/square, or between 1 Ohm/square and 10,000 Ohm/square, or between 1 Ohm/square and 100,000 Ohm/square. In some cases, the sheet resistance of the SCMs is measured by forming a film (e.g., when the SCMs are formulated into a slurry with a volatile solvent, coated, and dried), and using a four-point probe measurement, or an eddy current based measurement.

SCMs with high electrical conductivity can be created by vapor depositing metals onto the clusters in such a way as to prevent pore surface clogging of the carbon particle media. In some applications, these high-conductivity SCMs are slurry deposited (i.e., as inks or toners for printers). Optionally, a heated calendaring roller can compress and melt the metals in the SCM particles together to connect the porous media (e.g., graphene containing carbon material) without the use of binders. In some cases, the SCM particles can be exposed to microwave radiation that can be used to melt a low melting point ECM (e.g., silver, or antimony), thereby embedding the porous media of the SCM particles in a highly conductive metal matrix.

The thickness of the ECM deposited decorations on the surfaces and/or within the pores of the carbon particle porous media, can have a thickness from 1 monolayer (e.g., less than 1 nm thick) to several layers thick (e.g., less than a few nanometers thick). In other cases, the thickness of the ECM deposited decorations on the surfaces or within the pores of the carbon particle porous media can have a thickness from 1 nm to 100 nm thick, or from 0.1 microns to 100 microns.

In some cases, the carbon particle porous media can be pre-treated before being decorated with the ECM. Some examples of pre-treatments are chemical etches, plasma etches, mechanical size reduction, or combinations of chemical and mechanical processes. Some non-limiting examples of pre-treatments include mechanical processing, such as ball milling, grinding, attrition milling, micro-fluidizing, jet milling, and other techniques to reduce the particle size without damaging the carbon allotropes contained within. Other examples of pre-treatments include exfoliation processes such as shear mixing, chemical etching, oxidizing (e.g., Hummer method), thermal annealing, doping by adding elements during annealing (e.g., S, and N), steaming, filtering, and lypolizing, among others. Other examples of pre-treatments include sintering processes such as SPS (Spark Plasma Sintering, i.e., Direct Current Sintering), microwave, microwave plasma, and UV (ultraviolet), which can be conducted at high pressure and temperature in an inert gas. In some embodiments, multiple pre-treatment methods can be used together or in series. These pre-treatments can be useful to modify the morphologies and/or surfaces of the carbon particle porous media before applying the ECM decorations. For example, pre-treatments can change the surface energy of the carbon particle porous media so the ECM can more effectively penetrate into the small pores of the carbon particle porous media.

The carbon particle porous media can be decorated with an active material can then be deposited on the surfaces and/or within the pores of the carbon particle porous media and then optionally coated with the ECM. The resulting material is an SCM with a carbon particle porous media that is optionally decorated with an ECM and an active material. The active material can be deposited using any conformal deposition technique capable of depositing the active material on the surfaces and/or within the pores of the porous media optionally coated with the ECM. Some examples of conformal deposition techniques that can be used to deposit the active material are solution deposition techniques (e.g., chemical bath deposition, sol-gel deposition, particle printing, etc.) and vapor deposition techniques (e.g., sputtering, evaporation, chemical vapor deposition, atomic layer deposition (ALD), etc.).

The carbon particle and/or the ECM porous media can have a high porosity and can be decorated with an active material that can penetrate into the pores can occupy a large volume of the SCM. In some embodiments, the mass fraction of the active material compared to the total mass of the SCM is greater than 20%, or greater than 40%, or greater than 60%, or greater than 80%, or from 10% to 90%, or from 50% to 90%, or from 60% to 90%.

In some embodiments, the active material will alloy with the material in the carbon particle porous media or the materials in the carbon particle porous media coated with the ECM. For example, in some processes, the active material is deposited at an elevated temperature, which can melt or partially melt the carbon particle porous media and/or conductive particles and the active material will alloy with the underlying materials upon deposition. In other cases, the carbon particle porous media and/or conductive particles will not melt or will partially melt during the active material deposition, but the elevated temperatures enable the active material to diffuse into the underlying materials causing some degree of alloying between the active materials and underlying materials.

In some embodiments, coating the carbon particle porous media with other films (i.e., an ECM and/or active material) will densify carbon particle the porous media by filling in some of the voids (i.e., pores) in the core material. The same can be true for other examples of film deposition on the carbon particle porous materials described herein. Furthermore, the act of sintering (welding or coalescing) can also densify the less dense carbon particle porous materials into a denser SCM.

In some embodiments, the carbon particle porous media has a high electrical conductivity (e.g., a conductive carbon allotrope), as described above. In such cases, the coating of additional ECMs may or may not be required. In some embodiments, the carbon particle porous media, is itself an active material. In such cases, the coating of additional active materials may or may not be required.

FIG. 12 illustrates an embodiment of a process for microwave sintering of the carbon graphene particles that may or may not be decorated with conductive materials is illustrated. The carbon particles can be coupled to each other to create the different components of the fuel cell 501. In an embodiment, the metal decorated carbon particles can be pressed together in a pressurized mold, spray deposited to form a component layer of the fuel cell structure, or bonded together in any other suitable method. The carbon particles can also be known as a “carbon nano onion” that is decorated with a conductive material or not decorated.

The carbon particles in the fuel cell component layers can be exposed to microwave energy 503 in a microwave processing chamber that permits selective heating of a wide variety of materials, conductors and dielectrics. Through materials engineering of size, conductivity and/or loss tangent it is possible to configure the fuel cell component particles so that they selectively absorb microwave radiation allowing highly localized control over sintering of materials through local temperature control. The controlled microwave energy exposure allows the outer surfaces of the particles to be sintered without overheating the cores of the particles. More specifically, during microwave processing, the central core of the particles can remain at a relatively low temperature while core shell or the temperature of the surrounding decorations is much higher.

The selective heating of the fuel cell component particles allows the adjacent particles to be bonded to each other and sintered without over-diffusion of the surface materials. The microwaves direct electro-magnetic energy at the carbon particles that can heat the carbon particles. The carbon particles can absorb the electro-magnetic energy that results in electrical currents and ohmic heating 505. The microwave energy can heat the exterior surfaces to a higher temperature than the center core of the carbon particles 507. If the carbon particles are decorated with metal particles, the metal decorations can absorb the electro-magnetic energy than the carbon particles so that the metal decorations can become hotter than the carbon particle. The temperatures of the exterior surfaces can rise above a melting temperature of the materials and the particles can be sintered and the adjacent particles can be fused to each other at their contact points 509. The microwave processing allows the fuel cell components particles to be sintered much faster than traditional sintering furnaces.

The component construction with carbon graphene particles that are decorated with conductive materials or undecorated results in fuel cell components that have higher surface areas than known fuel cells. The power density for the fuel cell can be increased with higher porosity and higher surface area. Thus, the component construction with carbon graphene particles as described above, can also result in better control of the porosity. By optimizing the porosity and surface area, the power density of the fuel cell can be improved and optimized.

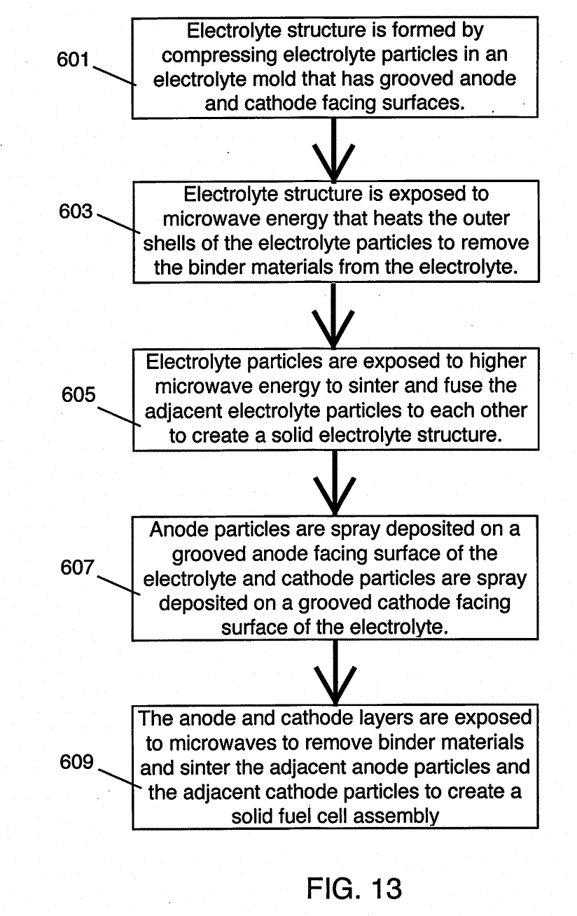

FIG. 13 is a flowchart of an embodiment of a process for fabricating an embodiment of the inventive fuel cell. The solid flexible electrolyte is formed by compressing electrolyte particles in an electrolyte mold that has grooved anode and cathode facing surfaces 601. The molded electrolyte structure is then exposed to microwave energy that heats the outer shells of the electrolyte particles to remove the binder materials from the electrolyte 603. Electrolyte particles are exposed to higher microwave energy to sinter and fuse the adjacent electrolyte particles to each other to create a solid electrolyte structure 605. Microwave energy can also be used to anneal the electrolyte.

Anode particles can be spray deposited on a grooved anode facing surface of the electrolyte and cathode particles are spray deposited on a grooved cathode facing surface of the electrolyte 607. The anode and cathode layers are exposed to microwaves to remove binder materials and sinter the adjacent anode particles and the adjacent cathode particles to create a solid fuel cell assembly 609. Microwave energy can also be used to drive off the binder materials from the anode and cathode layers and anneal the anode and cathode layers.

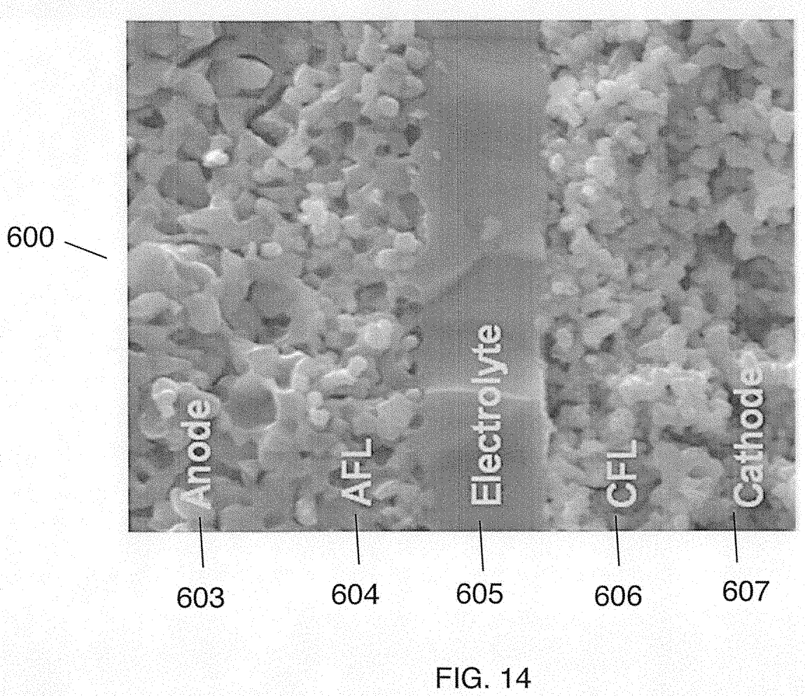

FIG. 14 is a photograph of a cross section of a fuel cell 600 having an anode 603, an anode functional layer (AFL) 604, an electrolyte 605, a cathode functional layer (CFL) 606, and a cathode 607. The anode 603 and AFL 604 can be fabricated from carbon particles that are decorated with conductive anode materials. The cathode 607 and CFL 606 can be fabricated from carbon particles that are decorated with conductive cathode materials. The anode 603 and anode functional layer 604 form a porous structure from carbon particles decorated with sintered conductive anode materials. The decorated carbon particles are fused together at their contact points. Similarly, the cathode 607 and the cathode functional layer 606 form a porous structure from carbon particles decorated with conductive cathode materials that have been sintered. The decorated carbon particles are fused together at their contact points. In contrast to the other components, the electrolyte 605 has a higher density and a lower porosity than the anode 603, the AFL 604, the CFL 606, and the cathode 607. The AFL 604 can be fused to the anode facing surface of the electrolyte 605 and the CFL 606 can be fused to the cathode facing surface of the electrolyte 605 at a 3 phase reaction boundary area.

The inventive fuel cell fabrication process is faster and more energy efficient than known fuel cell fabrication processes. It can currently take several days to fabricate fuel cells. In contrast, the fabrication time for the inventive fuel cell components can be completed in several minutes. Traditional fuel cells require long duration high temperature processing which requires substantial amounts of energy. Because the inventive fabrication processes use microwave energy for sintering, a much lower quantity of energy is required.

Known methods for fuel cell fabrication utilize industrial furnaces to heat and sinter the electrolyte particles. The electrolytes are formed from ceramic powder particles that are pressed into discs. It can take several hours for the internal heat of the furnace to be ramped up to the required processing temperature. Once the proper temperature is reached, the electrolyte particle discs are then placed into the industrial furnace. The electrolyte particle discs may need remain in the furnace for 24 or more hours to drive off the binders that hold the electrolyte particles together. The furnace heat is then further ramped up to the sintering temperature and the electrolyte particle discs are heated at the higher temperature for another 24 hours or longer to perform the sintering of the electrolyte particles. Once the electrolyte particles are sintered, the furnace temperature is slowly ramped down to an ambient temperature over 8-24 hours.

The electrolyte discs are then slip cast to attach the anode and cathode to opposite sides of the electrolyte discs to create the fuel cell structures. The described furnace heating process is then repeated on the fuel cell structure with the internal heat of the furnace being ramped up over hours and then held at a temperature that is sufficient to drive off the binders in the anode and cathode layers. The furnace heat is then ramped to the sintering temperature (approximately 1400 degrees C., depending on the materials being sintered) and the fuel cell structure is held at this temperature for 24 hours or longer to perform the sintering of particles in the anode and cathode layers. Once the anode and cathode particles are sintered, the furnace temperature is slowly ramped down to an ambient temperature over an additional 8-24 hour period to complete the fuel cell. The fabrication and furnace processing of known fuel cells can cumulatively take several days to complete and require a substantial amount of energy to heat the furnace. In contrast to the furnace processing of prior art fuel cells, the inventive microwave processing is much more energy and time efficient. Thus, the inventive fuel cell fabrication process is both faster and less costly.

In some embodiments, a dense electrolyte structure provides a backbone for the mechanical integrity of the fuel cell assembly. In some embodiments, the structural electrolyte component is manufactured from decorated or undecorated carbon particles such as graphene. The carbon particles can be decorated with ionic conducting ceramic materials such as yttria-stabilized zirconia (YSZ) or gadolinia-doped ceria (GDC), or other suitable materials.

In various embodiments, the electrolyte can be made with either in-situ or ex-situ microwave energy dosing for rapid thermal annealing. Using a solid electrolyte in the fuel cell can allow the thickness of the anode and cathode dramatically thinner which can reduce the reactant transport resistance through the electrodes. Microwave energy can also be used to: enhance the fuel cell component material density, remove unwanted materials impurities, and reduce residual stresses in the bulk fuel cell component materials that are produced.

The fuel cell electrolytes can have high area-specific resistances (ASR) due to long ionic conduction paths through the thick electrolyte. In some embodiments, it can be desirable to have thinner electrolytes that still provides the required mechanical strength. The anode facing and cathode facing surfaces of the electrolytes can be processed by micromachining to form the desired pattern of grooves described above. The micromachining for the electrolytes of the fuel cell can be similar to the micromachining used in plasma display manufacturing that includes micro surface channeling and 3D surface architecture formation. Micromachining of the electrolyte and possibly other components is cost-effective and a viable alternative to chemical plasma etching methods known in semiconductor fabrication technologies. As discussed, fuel cells can benefit from this surface processing by enlarging the reaction surface areas including the interfaces between the anode and the electrolyte and the interfaces between the cathode and electrolyte (3 phase reaction boundary area) by several hundred percent.

Carbon Particles

As discussed, the components of the fuel cell can be fabricated from carbon particles that can be decorated or undecorated. Surface decoration on carbon structures have the benefit of creating fuel cell structures that have higher porosity as well as higher proton and electrical conductivity. In some embodiments, the ceramic particles used to create each of the fuel cell components (anode, cathode, and electrolyte) are metal decorated graphene particles that can be produced by a methane reactor that converts methane into hydrogen and carbon particles. The methane reactor can have a processing chamber where the carbon particles can be decorated. The anode, cathode, and electrolyte fuel cell components can be fabricated from carbon particles that are decorated with different anode, cathode, and electrolyte material decorations.

The carbon particles that form the anode, cathode, and electrolyte, can be carbon or graphene particles that are decorated with various anode, cathode, and electrolyte materials. Conductive anode materials, conductive cathode materials, and conductive electrolyte materials can be used to decorate the carbon particles to form the anode particles, cathode particles, and electrolyte particles. The decorative conductive anode materials, conductive cathode materials, and/or conductive electrolyte materials can include: lithium-containing compounds; elemental sulfur, sulfur containing compounds, lithium nickel cobalt manganese oxide (NMC), lithium iron phosphate (LFP), boron, bromine, platinum, nickel, silver, molybdenum, iron, or any combination thereof. The carbon particles can be decorated with materials in various states such as: solid, metal molten liquid, suspension, dissolved solution, or any combination thereof. The decorations on the carbon particles can also include surfactant materials that can reduce pore clogging of the electroactive decoration materials. Possible surfactant materials can include: silver, antimony, amorphous carbon, hydroxy functional groups, or any combination thereof.

In some embodiments, the cores of the anode, cathode, and/or electrolyte particles can be fabricated from a plurality of aggregates that can include carbon nanoparticles such as graphene-containing allotropes, graphite, graphene platelets, spherical fullerenes, connected spherical fullerenes, graphene-coated spherical fullerenes, graphene platelets, carbon nanotubes, carbon nano onions (CNOs), amorphous carbon, or any combination thereof.

In some embodiments, the carbon particles can have high compositional purity, high electrical conductivity, and a high surface area. In some embodiments, the carbon particles also have a structure that is beneficial for specific applications. In some cases, a mesoporous structure can be characterized by a structure with a wide distribution of pore sizes (e.g., with a multimodal distribution of pore sizes). For example, a multimodal distribution of pore sizes can be indicative of structures with high surface areas and a large quantity of small pores that are efficiently connected to the substrate and/or current collector via material in the structure with larger feature sizes (i.e., that provide more conductive pathways through the structure).

In some embodiments, the particulate carbon materials contained in the porous media and/or conductive particles described herein are produced using microwave plasma reactors and methods, such as any appropriate microwave reactor and/or method described in U.S. Pat. No. 9,812,295, entitled “Microwave Chemical Processing,” or in U.S. Pat. No. 9,767,992, entitled “Microwave Chemical Processing Reactor,” which are assigned to the same assignee as the present application, and are incorporated herein by reference as if fully set forth herein for all purposes. Additional information and embodiments for microwave plasma gas processing system methods and apparatuses to produce the carbon nanoparticles and aggregates described herein are also described in the related U.S. patents and patent applications mentioned in this application.

In some embodiments, the particulate carbon materials in the porous media and/or conductive particles described herein are described in U.S. Pat. No. 9,997,334, entitled “Seedless Particles with Carbon Allotropes,” which is assigned to the same assignee as the present application, and is incorporated herein by reference as if fully set forth herein for all purposes. In some embodiments, the particulate carbon materials contain graphene-based carbon materials that comprise a plurality of carbon aggregates, each carbon aggregate having a plurality of carbon nanoparticles, each carbon nanoparticle including graphene, optionally including multi-walled spherical fullerenes, and optionally with no seed particles (i.e., with no nucleation particle). In some cases, the particulate carbon materials can be produced without using a catalyst. The graphene in the graphene-based carbon material has up to 15 layers.

In some embodiments, a ratio percentage of carbon to other elements in the carbon particle aggregates can be greater than 99%. A median size of the carbon aggregates can be from 1 micron to 50 microns, or from 0.1 microns to 50 microns. A surface area of the carbon aggregates is at least 10 m²/g, or is at least 50 m²/g, or is from 10 m²/g to 300 m²/g, or is from 50 m²/g to 300 m²/g. The carbon aggregates, when compressed, can have an electrical conductivity greater than 500 siemens per meter (S/m), or greater than 5000 S/m, or from 500 S/m to 20,000 S/m.

In some embodiments, the carbon particles in the porous media and/or conductive particles described herein are also described in U.S. Pat. No. 9,862,606 entitled “Carbon Allotropes,” which is assigned to the same assignee as the present application, and is incorporated herein by reference as if fully set forth herein for all purposes. In some embodiments, the carbon particles can include carbon nanoparticles comprising at least two connected multi-walled spherical fullerenes, and layers of graphene coating the connected multi-walled spherical fullerenes. Additionally, the carbon allotropes within the carbon nanoparticles can be well ordered. For example, a Raman spectrum of the carbon nanoparticle using 532 nm incident light can have a first Raman peak at approximately 1350 cm′ and a second Raman peak at approximately 1580 cm⁻¹, and a ratio of an intensity of the first Raman peak to an intensity of the second Raman peak is from 0.9 to 1.1. In some cases, the atomic ratio of graphene to multi-walled spherical fullerenes is from 10% to 80% within the carbon nanoparticles.

Methods of Manufacture

In some embodiments, the particulate carbon materials described herein can be produced using thermal cracking apparatuses and methods, such as any appropriate thermal apparatus and/or method described in U.S. Pat. No. 9,862,602, entitled “Cracking of a Process Gas,” which is assigned to the same assignee as the present application, and is incorporated herein by reference as if fully set forth herein for all purposes. Additional information and embodiments for thermal cracking methods and apparatuses to produce the carbon nanoparticles and aggregates described herein are also described in the in the related U.S. patents and patent applications mentioned in this disclosure.

In some embodiments, the carbon particles in the porous media and/or conductive particles contain more than one type of carbon allotrope. For example, the carbon particles can contain graphene, spherical fullerenes, amorphous carbon, and/or other carbon allotropes. Some of these carbon allotropes are further described in the related U.S. patents and patent applications mentioned in this disclosure. Additionally, the different carbon allotropes in the particulate carbon can have different morphologies, such as mixtures of low and high aspect ratios, low and high surface areas, and/or mesoporous and non-mesoporous structures. The use of carbon particles with combinations of different allotropes (and in some cases different morphologies) can enhance the electrical and mechanical properties of fuel cell components. The mass ratio of a first carbon allotrope (e.g., with high electrical conductivity and/or a mesoporous structure) to a second carbon allotrope (e.g., a long chain carbon allotrope) in the particulate carbon can be from 70:30 to 99:1, or from 80:20 to 90:10, or from 85:15 to 95:5, or is about 85:15, or is about 90:10, or is about 95:5. For example, mesoporous carbon allotropes in the particulate carbon can provide high surface area and/or high electrical conductivity, and the addition of long chain (i.e., high aspect ratio) carbon allotropes in the particulate carbon can improve the mechanical strength, adhesion and/or durability of the electrolyte, cathode, and/or anode layers of the fuel cell.

In some embodiments, the carbon particles in the porous media and/or conductive particles contains particles containing graphene (e.g., with one or more of the properties described herein), and particles containing long chain carbon allotropes (e.g., spherical fullerenes connected in a string-like arrangement, or carbon nanotube bundles). In some embodiments, the long chain carbon allotropes have aspect ratios greater than 10:1, or from 10:1 to 100:1, or about 10:1, or about 20:1, or about 50:1, or about 100:1. In some embodiments, the long chain carbon allotropes have dimensions from 50 nm to 200 nm wide by up to 10 microns in length, or from 10 nm to 200 nm wide by from 2 microns to 10 microns in length. Additional particles containing long chain carbon allotropes are described in the related U.S. patents and patent applications mentioned in this disclosure. The mass ratio of a graphene-containing carbon allotrope to a long chain carbon allotrope in the particulate carbon can be about 85:15, or about 90:10, or about 95:5. In some embodiments, the long chain carbon allotropes can interlock with other conductive (and in some cases structured, or mesoporous) carbon allotropes in the particulate carbon and can form an interlocked hybrid composite allotrope electrode with improved mechanical properties compared to electrodes without long chain carbon allotropes. In some embodiments, the addition of long chain (e.g., fibrous like) carbon increases the medium range (e.g., 1 micron to 10 microns) conductivity, and increases the distribution of the other carbon allotrope (e.g., prevents agglomeration of the other carbon allotrope, such as mesoporous graphene particles), while improving mechanical stability of the SCM.

The addition of long chain carbon allotropes can provide additional porosity around the carbon chain, which increases ion conductivity and mobility in the electrode. For example, the long chain carbons enable reduced calendering pressure during fuel cell fabrication, while maintaining the same (or better) mechanical stability (i.e., tolerance to delamination of the fuel cell layers) without long chain carbons that are calendered at higher pressures. Reduced calendering pressure can be advantageous because the higher porosity achieved using a lower pressure leads to increase ion conductivity and/or mobility. Additionally, in some embodiments, the addition of long chain carbon (e.g., fibers) can improve the elongation/strain tolerance. In some cases, the elongation/strain tolerance (e.g., the maximum strain to failure, or the amount of performance degradation for a given strain) can be increased by as much as 50%. In some structures in this example, the addition of long chain carbon allotropes to the particulate carbon enables the use of fewer binders, or the elimination of the binders.

In some embodiments, the carbon particle porous media and/or conductive particles can be doped with another material (e.g., H, O, N, S, Li, Cl, F, Si, Se, Sb, Sn, Ga, As, and/or other metals). Doping can be advantageous because it can tune the properties of the carbon particles. For example, doping with a metal can improve the conductivity of the carbon particles, and doping with oxygen can change the surface energy of the carbon particles. The described SCMs can include beneficial materials and structures for electrolytes, cathodes, and/or anodes in fuel cells.

In the present disclosure, compositions and methods for making metal-decorated 3D graphene are described. In some cases, the metal-decorated 3D graphenes are referred to as structured composite materials (SCMs). The terms “3D graphene” or “3D graphenes”, or “structured composite materials” are used interchangeably.

In various embodiments, the 3D graphenes can contain different combinations of porous media, conductive particles, electrically conductive materials (ECMs), and/or active materials. In some embodiments, the porous media provides a structural framework (or scaffold) and the ECM provides high electrical conductivity to the SCM. In some cases, the ECM is deposited on the surfaces and/or in the pores of the porous media and forms a continuous (or semi-continuous, with some disconnected regions and/or islands) matrix and/or a coating throughout the SCM. In some cases, the porous media and the conductive particles are coalesced (or, welded together) by depositing an ECM. The resulting SCMs contain the porous media and conductive particles embedded in a matrix of the ECM. In some cases, the active material is deposited on the surfaces and/or in the pores of the ECM and provides activity (e.g., energy storage capacity) to the SCM.

The present SCMs can be tailored for use in fuel cells, and/or as energy storage materials, electronic materials, optical materials, structural materials, and others. The chemical composition and morphology of the porous media, conductive particles and/or the ECM in the SCMs can be different in different configurations. For example, active materials can include materials for fuel cells, batteries, capacitors, sensors, inks, printed circuits, Internet of Things (IoT) applications, metamaterials for electromagnetic films, electrochemical sensors, and materials for impedance spectroscopy, aerospace applications, automotive industries, light absorbing applications, electro-optics systems, satellites, or telescopes. In some embodiments, the active material is deposited within the pores of the porous media, the pores of the conductive particles, and/or the pores of the ECM material, and the resulting SCMs have improved properties compared to conventional composites.

The terms nanostructured, micro-structured, and meso-structured materials, as used herein, are materials with physical features (e.g., pores, precipitates, particles, and fibers) with average sizes in the 1 nm to 10 nm range in the case of nanostructured materials, 100 nm to 10 micron range in the case of micro-structured materials, and with a wide distribution of sizes in the case of mesoporous materials.

Some non-limiting examples of active materials for the present SCMs are sulfur, sulfur compounds, silicon, silicon compounds, boron, bromine, and platinum, nickel, silver, molybdenum, and iron, however, the materials and methods described herein are applicable to many different active materials.

Throughout this disclosure, the SCMs are often described in the context of fuel cell applications (e.g., in electrolytes, anodes or cathodes), however, the examples above illustrate that the materials and methods described herein are applicable to many different applications.

In some embodiments, an SCM can contain porous media coated with ECM and can have a large surface area and very small pores. Conventionally, it can be difficult to deposit additional material (e.g., an active material) into very small pores, especially if those pores have high aspect ratios. In some embodiments, the surface characteristics of the partially formed SCM and the deposition method of the additional material enable the additional material to efficiently be deposited within the small pores of the SCM, even into pores with high aspect ratios. For example, the average pore size can be less than 50 nm or less than 10 nm or less than 5 nm, with an aspect ratio of 1:10 (i.e., 10 times deeper than wide), or 1:5, or 1:2, or 1:1, and the additional material can fill more than 30%, or more than 40%, or more than 50%, or more than 60%, or more than 70%, or more than 80%, or more than 90% of the volume of the pore. In the case of a thin coating, then for the same pore sizes as above, the additional material coating can cover more than 30%, or more than 40%, or more than 50%, or more than 60%, or more than 70%, or more than 80%, or more than 90% of the surface area of the pore with the geometries described above.

In some embodiments, an initial coating of surfactant materials, such as silver, or antimony) are grown on the aforementioned materials to promote the additional material to fill the pores (e.g., with the geometries described above) without clogging. Tuning these surfactant materials (e.g., by varying coverage) can also be used to effectively tune the degree of pore volume filling of an additional material. In other examples, a thin wetting layer, such as a layer of amorphous carbon, or a surface functionalized with hydroxy groups, allows the additional material (especially if the additional material is a liquid) to more effectively infiltrate into the small pores.

In some embodiments, the porous media, conductive particles, and/or ECM can have a high surface area (e.g., greater than 50 m²/g), a high electrical conductivity (e.g., greater than 500 S/m), and/or a particular morphological structure (e.g., a mesoporous structure with a bi-modal pore size distribution, or with nanometer-scale pores interspersed within a 3D web of thicker more conductive branches). These properties can also be varied such that the SCMs are useful in different applications.

In some embodiments, the porous media, conductive particles, and/or ECM have a surface area, when measured using the Brunauer-Emmett-Teller (BET) method with nitrogen as the adsorbate (i.e., the “BET method using nitrogen”, or the “nitrogen BET method”) or the Density Functional Theory (DFT) method, that is from 50 to 300 m²/g, or from 100 to 300 m²/g, or from 50 to 200 m²/g, or from 50 to 150 m²/g, or from 60 to 110 m²/g, or from 50 to 100 m²/g, or from 70 to 100 m²/g.

In some embodiments, the porous media, conductive particles, and/or ECM have pore volumes greater than 0.1 cm³/g, or greater than 0.5 cm³/g, or from 0.1 cm³/g to 0.9 cm³/g, or from 0.2 to 10 cm³/g. The porous media, conductive particles, and/or ECM can contain pores with average pore diameters from 1 to 4.3 nm and pore volume per gram of 0.46 cm³/g, or average pore diameter of 8.3 nm and pore volume per gram of 0.31 cm³/g. In some embodiments, the porous media, conductive particles, and/or ECM can contain mixtures of microporous, mesoporous, or macro-porous materials with pore diameters from 1 nm to 10 nm, of from 1 nm to 50 nm, and pore volumes from 0.1 cm³/g to 1 cm³/g, or from 0.2 cm³/g to 10 cm³/g.

In some embodiments, the porous media and/or conductive particles are particles with approximate particle size (e.g., diameter in the case of spherical particles) less than 10 microns, or less than 1 micron, or less than 100 nm, or from 10 nm to 10 microns, or from 10 nm to 1 micron.

In some embodiments, the porous media, conductive particles and/or ECM have an electrical conductivity (e.g., when compressed into a pellet) greater than 500 S/m, or greater than 2000 S/m, or from 500 S/m to 5000 S/m, or from 500 S/m to 20,000 S/m. In some embodiments the porous media, conductive particles and/or ECM have an electrical sheet resistance less than 1 ohm/square, or less than 100 Ohm/square, or between 1 Ohm/square and 100 Ohm/square, or between 1 Ohm/square and 10,000 Ohm/square, or between 1 Ohm/square and 100,000 Ohm/square. In some cases, the electrical conductivity of the porous media, conductive particles and/or ECM is measured after compression (e.g., into a disk, pellet, etc.), or after compression followed by annealing. In some cases, the sheet resistance of the porous media, conductive particles and/or ECM have is measured by forming a film (e.g., by formulating particles into a slurry with a volatile solvent, coating, and drying), and using a four-point probe measurement, or an eddy current based measurement.

In different applications, the porous media can be electrically conductive, electrically insulating, or a semiconductor. A few non-limiting examples of porous media materials are carbon allotropes, silicon, silicon oxide, silica, diatomaceous earth, and silicon carbide; however, the materials and methods described herein are applicable to many different porous media materials. Throughout this disclosure, the porous media, conductive particles and/or ECM may be described as being composed of carbon allotropes, or carbon alloys, semiconductors, pure metals, or silicon, however, the materials and methods described herein are applicable to many different materials. For example, SCMs containing covetic materials (i.e., aluminum or copper intermixed with carbon) can be produced using plasma torch processing. The co-deposition within the plasma torch enables the formation of covetic materials.

In some embodiments, the porous media is composed of inorganic materials that are capable of withstanding high processing temperatures that are required for the downstream processes (e.g., greater than 500° C., or greater than 1000° C.). In other embodiments, the porous media is composed of materials with melting points and/or boiling points below the processing temperatures that are required for the downstream processes (e.g., greater than 500° C., or greater than 1000° C.). In some of these cases, the porous media will change phase in the downstream processes and intermix (e.g., melt-diffuse) with subsequently deposited materials.

In some embodiments, the ECM can be deposited on the porous media, and the porous media will change phase during the ECM deposition process. In some cases, the electrically conductive media and the porous media will intermix (e.g., melt-diffuse) during the ECM deposition process. In some cases, covetic materials can result from phase changes through the SCM production process, which allow the two components to effectively combine.

In some embodiments, the form factor of the fuel cell can be produced on the order of standard macro-size form factor, or it may be formed into a micro-size form factor on the size order of a household battery. Any appropriate size, scale, shape, or configuration may be used, depending on application constraints and requirements. Strictly as an illustration, a particular form factor can be selected based on a retrofit requirement. For example, a relatively large fuel cell form factor can be used to retrofit a large pickup truck to use a fuel cell rather than an ICE, whereas as relatively small fuel cell form factor can be used to retrofit a four-door sedan to use a fuel cell rather than an ICE.

Reference has been made to certain embodiments, and each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended embodiments and their equivalents. These and other modifications and variations to the present invention may be practiced by those of ordinary skill in the art, without departing from the scope of the present invention, which is more particularly set forth in the appended embodiments. Furthermore, those of ordinary skill in the art will appreciate that the foregoing description is by way of example only, and is not intended to limit the invention.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

What is claimed is:

1. A system for producing clean energy from methane, the system comprising:
a high-power reactor that dissociates methane (CH₄) into solid carbon (C) and hydrogen gas (H₂), wherein the high-power reactor is configured to dissociate the methane and to abate emission of greenhouse gasses;
an apparatus accessing a storage storing the hydrogen gas to supply an apparatus converting the H₂ to water (H₂O); and
an apparatus using a first portion of the solid carbon to produce a fuel cell array used in a vehicle comprising at least one of a fuel cell electric vehicle (FCEV), a battery electric vehicle (BEV), a hybrid electric vehicle (HEV), or a plug-in hybrid electric vehicle (PHEV), and wherein the fuel cell array comprises a multi-cell solid oxide fuel cell (SOFC) array, wherein the carbon for the fuel cell is formed into an integral structure with porous media and a plurality of conductive particles, and further comprising one of: a metal-decorated porous 3D carbonaceous material, a 3-phase boundary surface area, or a plurality of graphene-containing conjoined allotropes.

2. The system of claim 1 wherein the methane is sourced from at least one of: a natural gas deposit, a landfill site, and a livestock facility, and wherein the methane is collected for distribution to the high-power reactor through a methane capture and delivery system.

3. The system of claim 2 wherein the fuel cell comprises a hydrogen fuel cell, the system further comprising an interface to a hydrogen filling station receiving hydrogen from the dissociating reactor and providing the received hydrogen to the vehicle.

4. The system of claim 2 wherein the fuel cell comprises a methane fuel cell, the system further comprising an interface to a methane filling station receiving methane from a methane source.

5. The system of claim 1 wherein a second portion of the dissociated carbon is used in one or more carbon processing apparatus such as to manufacture components for the vehicle.

6. The system of claim 1 wherein the fuel cell comprises:
an electrolyte formed from a plurality of electrolyte particles, the electrolyte having an anode-facing surface and a cathode-facing surface opposite the anode-facing surface;
a porous anode layer formed from a plurality of anode particles that are decorated with a conductive anode material wherein the plurality of anode particles are abutting to each other and the porous anode layer is adjacent to the anode-facing surface of the electrolyte;
an anode electrode layer adjacent to the porous anode layer;
a porous cathode layer adjacent to the cathode-facing surface of the electrolyte; and
a cathode electrode layer adjacent to the porous cathode layer.

7. The system of claim 6 wherein the plurality of electrolyte particles and the plurality of anode particles are carbon particles.

8. The system of claim 1 wherein the fuel cell array has a micro-size form factor on the size order of a household battery.

9. The system of claim 1 wherein the high-power reactor comprises:
an amplifier-implemented microwave energy source;
a first gas input port coupled to a methane feedstock supply;
a second gas input port coupled to a metal-containing carrier gas supply;
a first output port of the reactor that is connected to a hydrogen collection facility; and
a second output port of the reactor that is connected to a solid carbon collection facility.

10. A method for producing clean energy from methane, the system comprising:
dissociating methane (CH₄) into carbon (C) and hydrogen gas (H₂), wherein a high-power reactor is configured to dissociate the methane and to abate emission of greenhouse gasses;
accessing a storage storing the hydrogen gas for supply to an apparatus converting the H₂ to water (H₂O); and
using a first portion of the dissociated carbon to produce a fuel cell array used in a vehicle comprising at least one of a fuel cell electric vehicle (FCEV), a battery electric vehicle (BEV), a hybrid electric vehicle (HEV), or a plug-in hybrid electric vehicle (PHEV), and wherein the fuel cell array comprises a multi-cell solid oxide fuel cell (SOFC) array; and
forming carbon for the fuel cell into an integral structure with porous media and a plurality of conductive particles, and further comprising one of: a metal-decorated porous 3D carbonaceous material, a 3-phase boundary surface area, or a plurality of graphene-containing conjoined allotropes.

11. The method of claim 10 wherein the methane is sourced from at least one of: a natural gas deposit, a landfill site, and a livestock facility, and wherein the methane is collected for distribution to the high-power reactor through a methane capture and delivery system, and further wherein a second portion of the dissociated carbon comprises manufactured components for the vehicle.

12. The method of claim 11 wherein the fuel cell comprises a hydrogen fuel cell, the method further receiving, from a hydrogen filling station, hydrogen from the dissociating reactor and providing the received hydrogen to the vehicle.

13. The method of claim 11 wherein the fuel cell comprises a methane fuel cell, the method further receiving, through a methane filling station, methane from a methane source.

14. The method of claim 10 wherein the fuel cell comprises:
an electrolyte formed from electrolyte particles, the electrolyte having an anode-facing surface and a cathode-facing surface opposite the anode-facing surface;
a porous anode layer formed from a plurality of anode particles that are decorated with a conductive anode material wherein the plurality of anode particles are abutting to each other and the porous anode layer is adjacent to the anode-facing surface of the electrolyte;
an anode electrode layer adjacent to the porous anode layer;
a porous cathode layer adjacent to the cathode-facing surface of the electrolyte; and
a cathode electrode layer adjacent to the porous cathode layer.

15. The method of claim 14 wherein the high-power reactor comprises:
an amplifier-implemented microwave energy source;
a first gas input port coupled to a methane feedstock supply;
a second gas input port coupled to a metal-containing carrier gas supply;
a first output port of the reactor that is connected to a hydrogen collection facility; and
a second output port of the reactor that is connected to a solid carbon collection facility.

16. A system for preventing emissions of greenhouse gases during manufacture of fuel cells and gaseous fuel for powering vehicles and power generating devices, comprising:
a first stage sourcing and distributing methane gathered from one or more natural terrestrial sources;
a reactor for dissociating the sourced methane into separate and component hydrogen (H) and carbon (C);
a zero emissions stage using a portion of the carbon to produce fuel cells for use in the vehicles or power generating devices, and a remainder of the carbon in one or more carbon applications; and
a storage storing the hydrogen as hydrogen gas for supply as the gaseous fuel for use in the vehicles or power generating devices.

17. The system of claim 16 wherein the one or more terrestrial sources comprise: a natural gas deposit, a landfill site, and a livestock facility, and wherein the methane is collected for distribution to the reactor through a methane capture and delivery system.

18. The system of claim 16 wherein the vehicle comprises at least one of a battery electric vehicle (BEV), a hybrid electric vehicle (HEV), a plug-in hybrid electric vehicle (PHEV), and a fuel cell electric vehicle (FCEV).

19. The system of claim 16 wherein the reactor produces graphene that as a component of the fuel cells, and wherein the fuel cells comprise multi-cell solid oxide fuel cell (SOFC) arrays.

20. The system of claim 19, wherein the carbon for the fuel cells is formed into an integral structure with porous media and a plurality of conductive particles, and in turn further comprising one of: a metal-decorated porous 3D carbonaceous material, or a 3-phase boundary surface area; or further comprising a plurality of graphene-containing conjoined allotropes.
